(19) United States
(12) Patent Application Publication
(10) Pub. No.: US 2007/0169135 A1
(43) Pub. Date: Jul. 19, 2007

(54) Disk drive device

(75) Inventors: Kiyoshi Omori, Tokyo (JP); Shigeru Tamura, Tokyo (JP); Hideaki Tsutsumi, Tokyo (JP)

Correspondence Address: WOLF GREENFIELD & SACKS, P.C., 600 ATLANTIC AVENUE, BOSTON, MA, 02210-2206, US

(73) Assignee: Sony Corporation, Tokyo (JP)

(21) Appl. No.: 11/604,459

(22) Filed: Nov. 27, 2006

(30) Foreign Application Priority Data
Nov. 30, 2005 (JP) JP2005-346908

(51) Int. Cl. G11B 17/04; G11B 7/00

(52) U.S. Cl. 720/658; 360/99.06

(57) ABSTRACT

A disk drive device includes a housing provided with a disk slot in which a large-diameter disk-like recording medium is inserted and from which the recording medium is ejected, an eject arm that ejects the large-diameter disk-like recording medium, and a disk conveying mechanism that rotationally moves at least the eject arm to an ejection position of the large-diameter disk-like recording medium. The eject arm is provided with a stopper that prevents insertion of a small-diameter disk-like recording medium. When the eject arm is rotationally moved to the ejection position, the stopper is rotationally moved to a position where the stopper is brought into contact with a side on an insertion end side of the small-diameter disk-like recording medium when substantially the entire small-diameter disk-like recording medium is inserted from the disk slot.

### CROSS-REFERENCES TO RELATED APPLICATIONS

This application contains subject matter related to Japanese Patent Application JP 2005-346908 filed in the Japanese Patent Office on Nov. 30, 2005, the entire contents of which being incorporated herein by reference.

### BACKGROUND OF THE INVENTION

1. Field of the Invention

The present invention relates to a disk drive device that records information signal in and/or reproduces information signal from an optical disk, and, more particularly to a disk drive device of a so-called slot-in type in which the optical disk is directly inserted into a housing.

2. Description of the Related Art

Optical disks such as a CD (Compact Disk), a DVD (Digital Versatile Disk), and a BD (Blue-ray Disk) and magneto-optical disk such as an MO (Magneto Optical) and an MD (Mini Disk) have been widely known. Various disk drive devices corresponding to these disks, disk cartridges, and the like have appeared in the market.

The disk drive devices include a disk drive device of a type for opening a cover or a door provided in a housing to directly mount a disk on a turntable exposed from the opened cover or door, a disk drive device of a type for placing a disk on a disk tray drawn in and drawn out from a housing in the horizontal direction to automatically mount the disk on a turntable in the disk drive device when the disk tray is drawn in, and a disk drive device of a type for directly mounting a disk on a turntable provided on a disk tray. However, in all the types of the disk drive devices, an operator needs to perform operation such as opening and closing of the cover or the door, pushing-in and drawing-out of the disk tray, and mounting of the disk on the turntable.

On the other hand, there are disk drive devices of a so-called slot-in type in which a disk is automatically mounted on a turntable simply by inserting the disk from a disk slot provided on a front surface of a housing. As one of the disk drive devices of the slot-in type, there is a disk drive device that includes a pair of guide rollers opposed to each other that hold a disk inserted from a disk slot and rotates the pair of guide rollers in directions opposite to each other to perform a loading operation for drawing in the disk inserted from the disk slot into the inside of a housing and an eject operation for ejecting the disk to the outside of the housing from the disk slot.

A further reduction in size, weight, and thickness is demanded for mobile apparatuses mounted with disk drive devices such as a notebook personal computer. Accordingly, there is an increasing demand for a reduction in size, weight, and thickness of the disk drive devices. Under such circumstances, as one of the disk drive devices of the slot-in type, there is a disk drive device in which a contact section brought into contact with the outer circumference of a disk inserted from a disk slot of a front panel is provided at a front end thereof and plural rotational arms having base ends thereof rotationally movably supported are arranged. The disk drive device performs a loading operation for drawing the disk into a housing from the disk slot and an eject operation for ejecting the disk to the outside of the housing from the disk slot while rotationally moving these rotational arms in a plane parallel to the disk (see, for example, JP-A-2002-117604). Among the disk drive devices having reduced thickness, an ultra-thin disk drive device mounted on the notebook personal computer and the like has thickness of 12.7 mm as a standard size. A disk drive device having thickness as small as 9.5 mm, which is equivalent to thickness of a hard disk drive (HDD) unit, is also proposed.

The disk drive device that has the plural rotational arms arranged therein and performs the disk loading operation and the eject operation while rotationally moving the these rotational arms in the plane parallel to the disk is designed on condition that an optical disk of a specified size, for example, an optical size having a diameter of 12 cm is used. Therefore, when a disk having a diameter smaller than 12 cm, for example, an optical disk having a diameter of 8 cm is inserted from a disk slot, it is difficult to accurately convey the optical disk to a recording and reproduction position with the plural rotational arms. Moreover, it is likely that it is difficult to eject the small-diameter optical disk from a housing.

Therefore, a mechanism for preventing, even when the small-diameter disk is inserted from the disk slot by mistake because of carelessness or the like of an operator, the small-diameter disk from entering the inside of the housing is necessary. As such a mechanism for preventing misinsertion of the small-diameter disk, a mechanism for providing an elastic stopper at the tips of the rotational arms and ejecting the small-diameter disk with elastic force of the stopper is proposed. However, when the operator pushes in the small-diameter disk against the elastic force of the stopper, the rotational arms are inadvertently moved rotationally to allow the small-diameter disk to enter the inside of the housing. Thus, there is still a problem of inability to pull out the small-diameter disk, breakage of the rotational arms or the stopper, or the like.

### SUMMARY OF THE INVENTION

Therefore, it is desirable to provide a disk drive device that can prevent, even when an optical disk having a diameter smaller than that of an optical disk having a specified diameter is inserted in the disk drive device by an operator by mistake, the small-diameter disk from being allowed to enter the inside of a housing.

According to an embodiment of the invention, there is provided a disk drive device including a housing provided with a disk slot in which a large-diameter disk-like recording medium is inserted and from which the recording medium is ejected, an eject arm that ejects the large-diameter disk-like recording medium, and a disk conveying mechanism that rotationally moves at least the eject arm to an ejection position of the large-diameter disk-like recording medium. The eject arm is provided with a stopper that prevents insertion of a small-diameter disk-like recording medium. When the eject arm is rotationally moved to the ejection position, the stopper is rotationally moved to a position where the stopper is brought into contact with a side on an insertion end side of the small-diameter disk-like recording medium when substantially the entire small-diameter disk-like recording medium is inserted from the disk slot.

### BRIEF DESCRIPTION OF THE DRAWINGS

In the accompanying drawings:

FIG. 1 is an external perspective view showing an electronic apparatus mounted with a disk drive device according to an embodiment of the invention;

FIG. 2 is an external perspective view showing the disk drive device according to the embodiment;

FIG. 3 is a perspective view showing the inside of the disk drive device according to the embodiment;

FIG. 4 is a perspective view showing the disk drive device from which a main chassis is removed;

FIG. 5 is an external perspective view showing a top cover;

FIG. 6 is a perspective view showing the inside of the disk drive device according to the embodiment;

FIG. 7 is a perspective view showing a base unit;

FIG. 8 is a sectional view showing a coupling portion of a base chassis and a sub-chassis;

FIG. 9 is a diagram for explaining a support structure by a damper between the base chassis and the sub-chassis in the base unit;

FIG. 10 is a perspective view showing another example of the disk drive device;

FIG. 11 is a sectional view showing another example of the disk drive device;

FIG. 12 is a plan view showing the start of insertion of an optical disk in a process for conveying the optical disk;

FIG. 13 is a plan view showing a state in which an eject arm is rotationally moved by the optical disk in a process for inserting the optical disk;

FIG. 14 is a plan view showing a state in which the eject arm and a loading arm are driven by a slider in the process for inserting the optical disk;

FIG. 15 is a plan view showing a state in which the optical disk is conveyed to a centering position in the process for inserting the optical disk;

FIG. 16 is a plan view showing a state in which the optical disk is released from the respective arms and allowed to freely rotate in the process for inserting the optical disk;

FIG. 17 is a plan view showing a state in which the optical disk is brought into contact with the respective arms in a process for ejecting the optical disk;

FIG. 18 is a plan view showing a state in which the optical disk is conveyed by the respective arms in the process for ejecting the optical disk;

FIG. 19 is a plan view showing a state in which the optical disk is conveyed by the respective arms in the process for ejecting the optical disk;

FIG. 20 is a plan view showing a state in which the optical disk is ejected to a predetermined position and stopped in the process for ejecting the optical disk;

FIG. 21 is a perspective view showing a loading cam plate;

FIG. 22 is a disassembled perspective view showing an eject arm;

FIG. 23 is a plan view showing a circuit board mounted with first to fourth switches and a slider that depresses these switches;

FIG. 24 is a timing chart at the time of loading of the optical disk;

FIG. 25 is a timing chart at the time of ejection of the optical disk;

FIG. 26 is a plan view showing a state in which the optical disk is gripped in the process for inserting the optical disk;

FIG. 27 is a perspective view showing a state in which the conveyance of the optical disk is hindered by an obstacle on a conveyance area in the process for ejecting the optical disk;

FIG. 28 is a perspective view showing the eject arm provided with a stopper;

FIG. 29 is a plan view showing a state in which misinsertion of a small-diameter optical disk is prevented;

FIG. 30 is a perspective view showing a disk drive device in which a guide projection for guiding rotational movement of the eject arm is provided on the upper surface of the main chassis;

FIG. 31A is a diagram showing a rotational movement locus of the eject arm guided by the guide projection and moved onto the guide projection;

FIG. 31B is a diagram showing a rotational movement locus of the eject arm guided by the guide projection and not moved onto the guide projection;

FIG. 32A is a perspective view showing the slider;

FIG. 32B is a perspective view showing a sub-slider;

FIG. 33 is a sectional view showing a positional relation between a guide pin and a guide hole, wherein (a) is a sectional view showing a chucking release position, (b) is a sectional view showing a disk mounting position, and (c) is a sectional view showing a recording and reproduction position;

FIG. 34 is a perspective view showing the guide pin and the guide hole in a state in which a base unit is lowered to the chucking release position;

FIG. 35 is a perspective view showing the guide pin and the guide hole in a state in which the base unit is lifted to a chucking position; and

FIG. 36 is a perspective view showing the guide pin and the guide hole in a state in which the base unit is lifted to the recording and reproduction position.

### DESCRIPTION OF THE PREFERRED EMBODIMENTS

A disk drive device according to an embodiment of the invention will be hereinafter explained in detail with reference to the accompanying drawings.

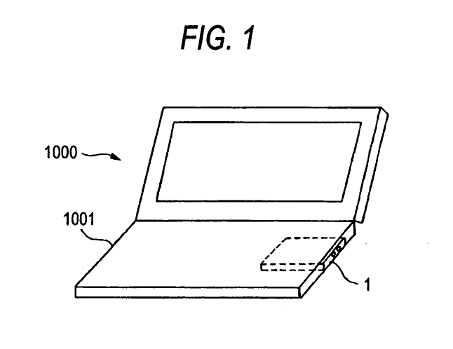

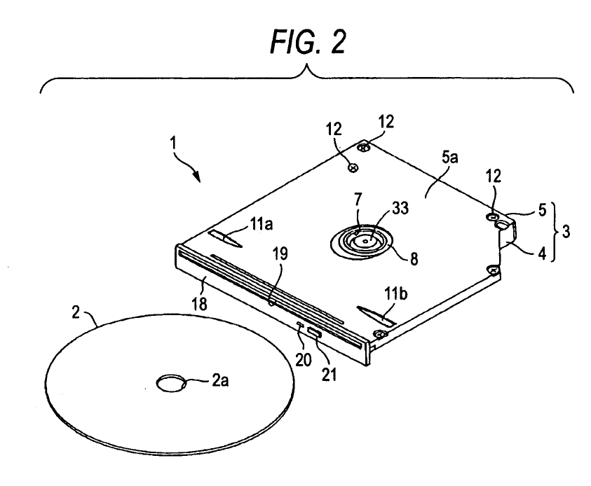

The disk drive device 1 is, for example, as shown in FIG. 1, a disk drive device 1 of a slot-in type mounted on an apparatus body 1001 of a notebook personal computer 1000. As shown in FIG. 2, the disk drive device 1 has a structure with thickness of the entire device reduced to as thin as, for example, about 12.7 mm. The disk drive device 1 is capable of recording an information signal in and reproducing an information signal from an optical disk 2 such as a CD (Compact Disk), a DVD (Digital Versatile Disk), or a BD (Blue-ray Disc).

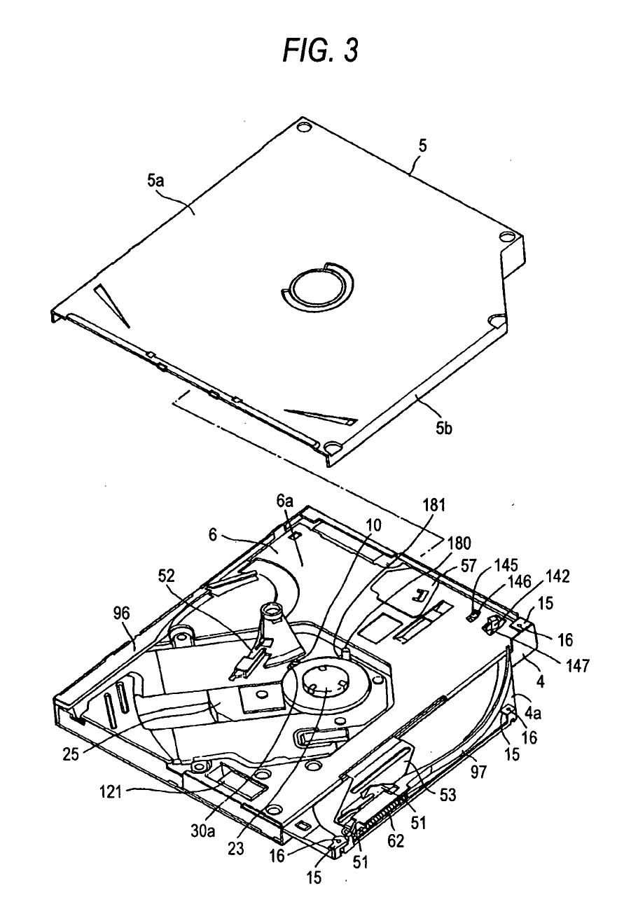

First, a specific structure of the disk drive device 1 will be explained. As shown in FIGS. 3 to 6, the disk drive device 1 includes a housing 3 serving as an outer housing of a housing. The housing 3 includes a bottom case 4 of a substantially flat box shape serving as a lower housing and a top cover 5 serving as a top plate that covers an upper opening of the bottom case 4. In the housing 3, a main chassis 6 is provided. The main chassis 6 covers a driving mechanism 120 that exposes a base unit 22 described later upward and provides a driving force for disk conveyance and a disk conveying mechanism 50 to which the driving force of the driving mechanism 120 is transmitted.

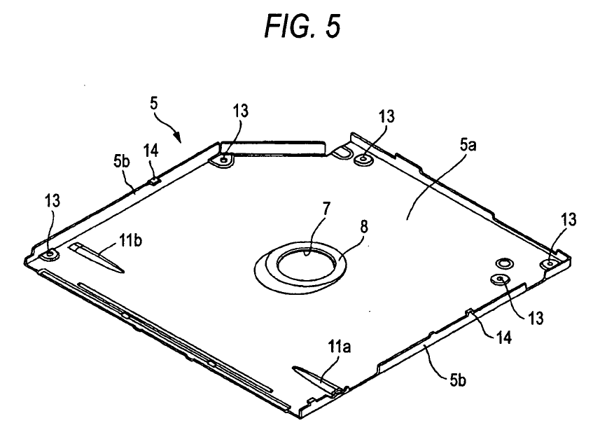

As shown in FIGS. 2 and 5, the top cover 5 is made of a thin sheet metal and has a top plate section 5a that closes the upper opening of the bottom case 4 and a pair of side plate sections 5b obtained by slightly bending the periphery of the top plate section 5a along both the sides of the bottom case 4. An opening 7 of a substantially circular shape is formed substantially in the center of the top plate section 5a. The opening 7 is an opening for exposing an engaging projection 33a of a turntable 23a engaged with a center hole 2a of the optical disk 2 to the outside at the time of a chucking operation described later. The periphery of the opening 7 of the top plate 5a forms a contact projection 8 slightly projected toward the inner side of the housing 3 to come into contact with the periphery of the center hole 2a of the optical disk 2 held on the turntable 23a.

On the front surface side of the top plate section 5a, a pair of guide projections 11a and 11b that guide the optical disk 2 inserted from a disk slot 19 described later while regulating the optical disk 2 in a height direction are formed to swell toward the inside of the housing 3. The pair of guide projections 11a and 11b are provided in positions substantially symmetrical to each other across a center line along an inserting direction of the optical disk 2 passing the opening 7. The pair of guide projections 11a and 11b have a substantially partial conical shape elevated to draw an arc in the inserting direction of the optical disk 2 and elevated such that the arc is reduced in diameter continuously from the outer side to the inner side over a direction substantially orthogonal to the inserting direction of the optical disk 2. In other words, the pair of guide projections 11a and 11b have a shape formed by dividing a cone along an axial direction and arranging tops of the respective divided cones to face the inner side of the top plate section 5a. The pair of guide projections 11a and 11b continuously decrease in height and width from the outer side to the inner side of the top plate section 5a.

Since the pair of guide projections 11a and 11b have such a shape, it is possible to smoothly guide the optical disk 2, which is inserted from the disk slot 19, to the inside of the housing 3 while correcting deviation in the width direction of the optical disk 2. In the top cover 5, since the guide projections 11a and 11b of such a shape are provided, it is possible to increase rigidity of the top plate section 5a. Work for reducing frictional resistance against the optical disk 2 is applied to a main surface on the inner side of the top plate section 5a.

The bottom case 4 is made of a sheet metal formed in a substantially flat box shape. The bottom surface thereof has a substantially rectangular shape. A deck section 4a raised higher than the bottom surface and extended to the outer side is provided on one side of the bottom case 4. A loading arm 51 described later that draws the optical disk 2 into the housing 3 is supported by the deck section 4a to freely move rotationally.

A circuit board 59 is attached to the bottom surface of the bottom case 4 by screwing or the like. Electronic components such as an IC chip constituting a driving control circuit, a connector for electrically connecting respective sections, a detection switch for detecting operations of the respective sections, and the like are arranged on the circuit board 59. A connector opening 4b that exposes the connector mounted on the circuit board 59 to the outside is provided in a part of the outer peripheral wall of the bottom case 4.

The top cover 5 is attached to the bottom case 4 by screwing. Specifically, as shown in FIG. 5, plural through holes 13, through which screws 12 are pierced, are formed at the outer peripheral edge of the top plate section 5a of the top cover 5. Plural guide pieces 14 bent to the inner side at substantially the right angle are provided in the side plate sections 5b on both the sides of the top plate section 5a. On the other hand, as shown in FIG. 3, plural fixing pieces 15 bent to the inner side at substantially the right angle are provided at the outer peripheral edge of the bottom case 4. Screw holes 16 corresponding to the through holes 13 of the top cover 5 are formed in these fixing pieces 15. Plural guide slits, details of which are not shown, serving as slip-off preventing portions for the plural guide pieces 14 of the top cover 5 are formed on both the sides of the bottom case 4.

In attaching the top cover 5 to the bottom case 4, the top cover 5 is slid from the front surface side to the rear surface side in a state in which the plural guide pieces 14 of the top cover 5 are engaged with the plural guide slits of the bottom case 4. Consequently, the top plate section 5a of the top cover 5 closes the upper opening of the bottom case 4. In this state, the screws 12 are screwed in the screw holes 16 of the bottom case 4 through the plural through holes 13 of the top cover 5. In this way, the housing 3 shown in FIG. 2 is constituted.

As shown in FIG. 2, a front panel 18 of a substantially rectangular flat shape is attached to the front surface of the housing 3. The disk slot 19, in which the optical disk 2 inserted and from which the optical disk 2 is ejected, is provided in the front panel 18. It is possible to insert the optical disk 2 into the inside of the housing 3 from the disk slot 19 and eject the optical disk 2 to the out side of the housing 3 from the disk slot 19. Not-shown panel curtains are formed on both sides in a direction orthogonal to the longitudinal direction of the disk slot 19. The panel curtains are made of non-woven fabric or the like cut in a long shape. The panel curtains are stuck to the rear surface side of the front panel 18 by an adhesive or the like to prevent dust and the like from entering the housing 3. When the optical disk 2 is inserted or ejected, the panel curtains come into sliding contact with the disk surface. Consequently, it is possible to remove dusts and the like adhering to the optical disk 2.

A display unit 20 that displays a state of access to the optical disk 2 with lighting and an eject button 21 that is depressed in ejecting the optical disk 2 are provided on the front surface of the front panel 18.

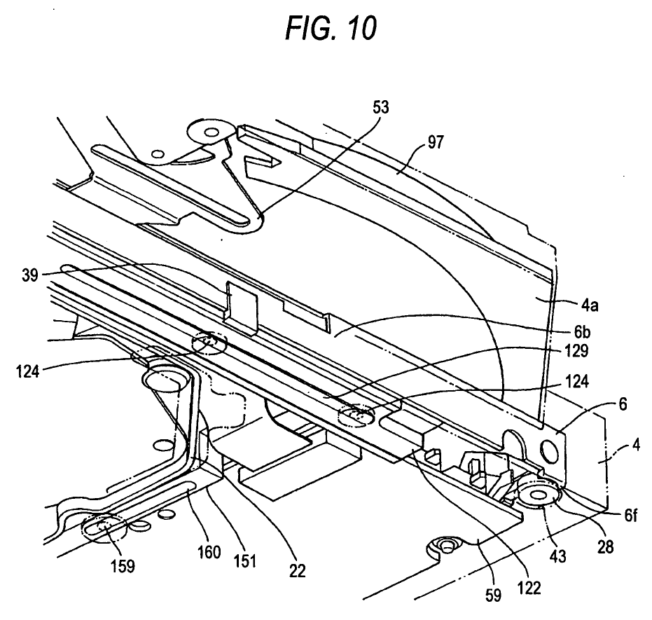

Near one side of the bottom case 4 on which the deck section 4a is provided, a pair of guide protrusions 124, 124 that slide a slider 122 of the driving mechanism 120 described later along the one side are protrudingly provided to be spaced apart from each other along the one side (see FIG. 10).

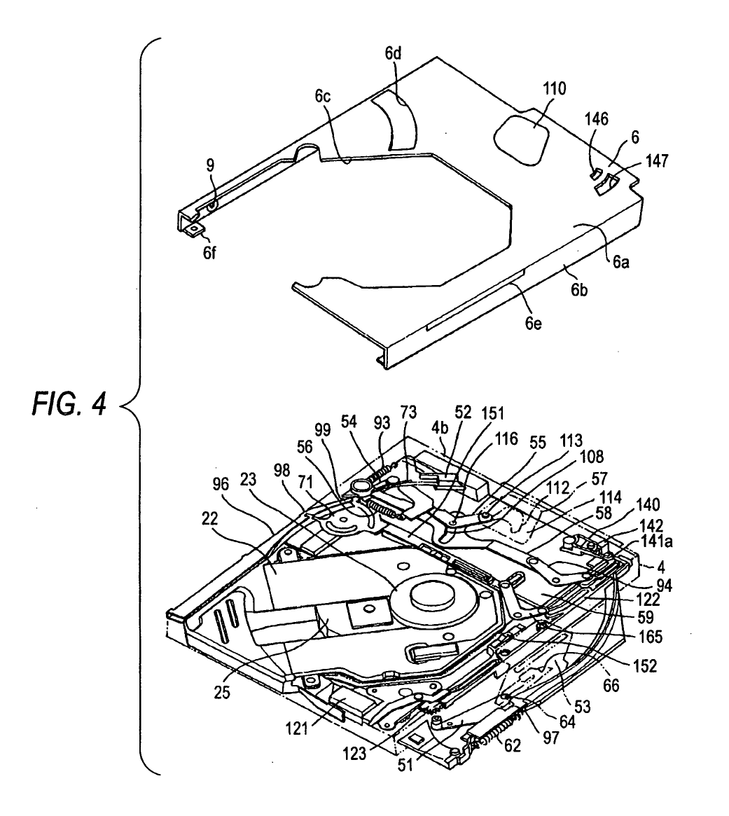

As shown in FIGS. 3 and 4, the main chassis 6 is attached to the bottom surface of the bottom case 4 by screwing. The main chassis 6 is arranged, above the circuit board 59, to partition the inside of the bottom case 4 into an upper section and a lower section at height substantially equivalent to that of the deck section 4a. Consequently, an area of the housing 3 further on the top cover 4 side than the main chassis 6 is set as a disk conveyance area in which the loading arm 51 and the eject arm 52 are exposed to freely move rotationally. An area of the housing 3 further on the bottom case 4 side than the main chassis 6 is set as an area in which the driving mechanism 120 including a driving motor 121 and the slider 122 and first and second link arms 54 and 55, an operation arm 58, and a loop cam 57 of the disk conveying mechanism 50 that transmits a driving force of the driving motor 121 to the eject arm 52 are disposed.

The main chassis 6 is made of a sheet metal of a substantially flat shape. The main chassis 6 has an upper surface 6a that covers the bottom case 4 from the rear surface side of the bottom case 4 to one side surface on which the deck section 4a is formed and a pair of side plate sections 6b obtained by bending the periphery of the upper surface 6a along both the sides of the bottom case 4. The main chassis 6 has formed in the upper surface 6a thereof a base opening 6c and an eject arm opening 6d that expose the base unit 22 and the eject arm 52 of the disk conveying mechanism 50 on the conveyance area of the optical disk 2, respectively. A side plate opening 6e, through which a loading cam plate 53 coupled to the slider 122 slid by the driving motor 121 is inserted, is formed in the side plate section 6b on a side on which the deck section 4a is provided. On the upper surface 6a of the main chassis 6, the eject arm 52 of the disk conveying mechanism 50 that conveys the optical disk 2 over the inside and the outside of the housing 3, the operation arm 58 that transmits a driving force of the driving mechanism 120 to operate the eject arm 52, and the loop cam 57 that guides the movement of the second link arm 55 are locked on the bottom case 4 side.

In the main chassis 6, plural guide pieces 6f bent to the inner side at substantially the right angle and through holes 6h for fixing the main chassis 6 to the bottom case 4 are provided in the side plate sections 6b on both the sides of the main chassis 6. On the other hand, in the bottom case 4, screw holes 4c are formed in positions corresponding to the through holes 6h. The main chassis 6 is fixed by screwing screws in the screw holes 4c and the through holes 6h.

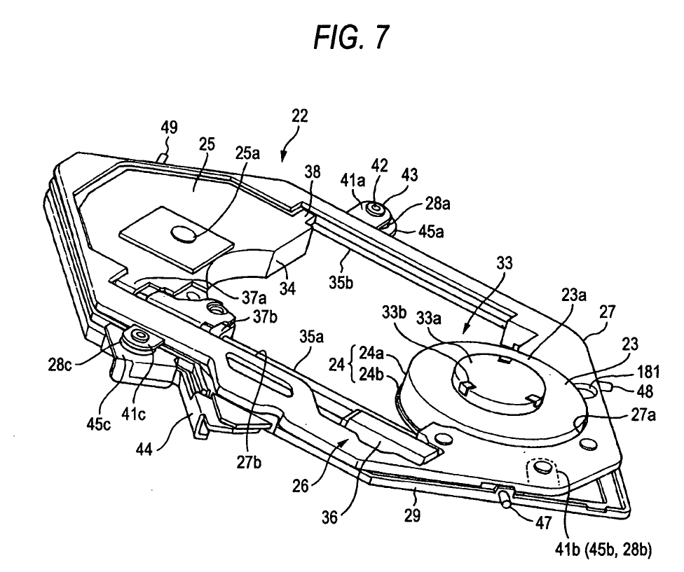

The disk drive device 1 includes, on the bottom surface of the bottom case 4, a base unit 22 that constitutes a drive body. As shown in FIG. 7, the base unit 22 has a base chassis 27 made of a frame member of a substantially rectangular shape. The base chassis 27 is supported by a sub-chassis 29 via plural dampers 28a to 28c. The base chassis 27 is disposed in the bottom case 4 via the sub-chassis 29, whereby one end side in the longitudinal direction of the base unit 22 is located substantially in the center of the housing 3. On the one end side in the longitudinal direction of the base unit 22, a disk mounting section 23 on which the disk 2 inserted into the housing 3 from the disk slot 19 and a disk-rotation driving mechanism 24 that drives to rotate the optical disk 2 mounted on the disk mounting section 23 are provided. The base unit 22 has an optical pickup 25 that writes a signal in and reads out a signal from the optical disk 2 driven to rotate by the disk-rotation driving mechanism 24 and a pickup feeding mechanism 26 that conveys the optical pickup 25 over the longitudinal direction to feed the optical pickup 25 in the radial direction of the optical disk 2. The optical pickup 25 and the pickup feeding mechanism 26 are provided integrally with the base chassis 27. The base chassis 27 is supported by the sub-chassis 29, whereby the base unit 22 is operated to rise and fall with respect to the optical disk 2 together with the sub-chassis 29 by a base elevating mechanism 150 described later.

The base unit 22 is exposed on the disk conveyance area from the base opening 6c of the main chassis 6 such that the disk mounting section 23 is located in substantially the center in the bottom surface of the bottom case 4. The base unit 22 is allowed to rise and fall by the base elevating mechanism 150 described later. In an initial state, the base unit 22 is located below the optical disk 2 inserted into the housing 3 from the disk slot 19. According to loading operation for the optical disk 2, the base unit 22 is lifted to rotatably engage with the optical disk 2. After a recording and reproduction operation, the base unit 22 is lowered by the base elevating mechanisms 150, released from the engagement with the optical disk 2, and retracted from the conveyance area of the optical disk 2.

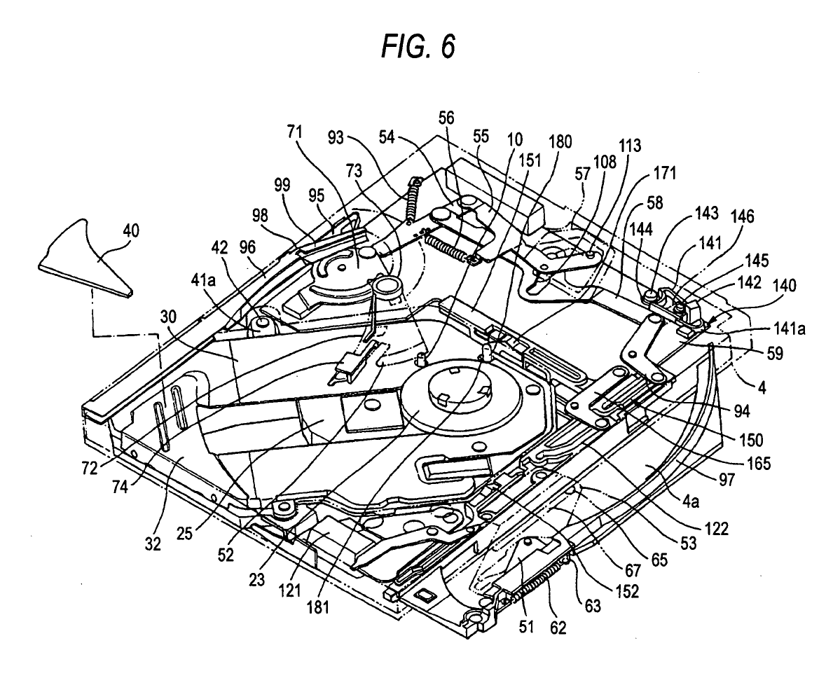

The base chassis 27 is formed by punching a sheet metal in a predetermined shape and slightly bending the periphery of the sheet metal downward. On a main surface of the base chassis 27, a table opening 27a of a substantially semi-circular shape that exposes the turntable 23a of the disk mounting section 23 described later upward and a pickup opening 27b of a substantially rectangular shape that exposes an object lens 25a of the optical pickup 25 upward are continuously formed. As shown in FIG. 6, a decorative plate 30, in which openings corresponding to the openings 27a and 27b are formed, is attached to the upper surface of the base chassis 27.

In the base chassis 27, at an end on the opposite side of the disk mounting section 23, a guide plate 32 that prevents contact of the optical disk 2 and the base chassis 27 and guides the optical disk 2 to a contact member 74 of the eject arm 52 is formed. A fiber sheet 40 is stuck to the guide plate 32. Even when the optical disk 2 is brought into sliding contact with the guide plate 32, it is possible to prevent a signal recording surface of the optical disk 2 from being scratched.

In the base chassis 27, coupling pieces 41a and 41b coupled to the sub-chassis 29 via the dampers 28a and 28b are protrudingly provided on both the sides in the longitudinal direction. Through holes 43 that are connected to coupling pieces 45a and 45b formed in the sub-chassis 29 and through which stepped screws 42 are inserted are drilled in the respective coupling pieces 41a and 41b.

The disk mounting section 23 has the turntable 23a driven to rotate by the disk-rotation driving mechanism 24. A chucking mechanism 33 for mounting the optical disk 2 is provided in the center of the turntable 23a. The chucking mechanism 33 has an engaging projection 33a engaged with the center hole 2a of the optical disk 2 and plural engaging pawls 33b that lock the periphery of the center hole 2a of the optical disk 2 engaged with the engaging projection 33a. The chucking mechanism 33 holds the optical disk 2 on the turntable 23a.

The disk-rotation driving mechanism 24 has a spindle motor 24a of a flat shape that drives to rotate the optical disk 2 together with the turntable 23a. The spindle motor 24a is attached to the lower surface of the base chassis 27 by screwing via a support plate 24b such that the turntable 23a provided on the upper surface slightly projects from the table opening 27a of the base chassis 27.

The optical pickup 25 has an optical block that condenses a light beam, which is emitted from a semiconductor laser serving as a light source, with the object lens 25a to irradiate the light beam on the signal recording surface of the optical disk 2 and detects the return light beam, which is reflected on the signal recording surface of the optical disk 2, with a photo-detector including a light receiving element. The optical pickup 25 writes a signal in and reads out a signal from the optical disk 2.

Further, the optical pickup 25 has an object-lens driving mechanism such as a biaxial actuator that drives to displace the object lens 25a in an optical axis direction (a focusing direction) and a direction orthogonal to a recording track of the optical disk (a tracking direction). The optical pickup 25 performs, on the basis of a detection signal from the optical disk 2 detected by the photo-detector, driving control such as focus servo for focusing the object lens 25a on the signal recording surface of the optical disk 2, tracking servo for causing the recording track to track a spot of a light beam condensed by the object lens 25a while displacing the object lens 25a in the focusing direction and the tracking direction with the biaxial actuator. As the object-lens driving mechanism, it is also possible to use a triaxial actuator that makes it possible to adjust inclination (skew) of the object lens 25a with respect to the signal recording surface of the optical disk 2 to irradiate the light beam condensed by the object lens 25a vertically on the signal recording surface of the optical disk 2 in addition to the focusing control and the tracking control.

The pickup feeding mechanism 26 has a pickup base 34 mounted with the optical pickup 25, a pair of guide shafts 35a and 35b that slidably support the pickup base 34 in the radial direction of the optical disk 2, and a displacement driving mechanism 36 that drives to displace the pickup base 34 supported by the pair of guide shafts 35a and 35b in the radial direction of the optical disk 2.

On the pickup base 34, a pair of guide pieces 37a and 37b having formed therein guide holes, through which one guide shaft 35a of the pair of guide shafts 35a and 35b is inserted, and a guide piece 38 having formed therein a guide groove, which holds the other guide shaft 35b, are formed to project from sides opposed to each other. Consequently, the pickup base 34 is slidably supported by the pair of guide shafts 35a and 35b.

The pair of guide shafts 35a and 35b are arranged on the lower surface of the base chassis 27 to be parallel to the radial direction of the optical disk 2. The pair of guide shafts 35a and 35b guide the pickup base 34, the optical pickup 25 of which is exposed from the pickup opening 27b of the base chassis 27, over the inner and the outer circumferences of the optical disk 2.

The displacement driving mechanism 36 converts rotational driving of the driving motor 31 attached to the base chassis 27 into linear driving via a gear and a rack (not shown) and drives to displace the pickup base 34 in a direction along the pair of guide shafts 35a and 35b, that is, the radial direction of the optical disk 2. For example, a stepping motor including a lead screw is used as the displacement driving mechanisms 36.

The sub-chassis 29 that supports such a base chassis 27 via dampers 28 will be explained. The sub-chassis 29 is operated to rise and fall by the base elevating mechanism 150 described later according to conveyance of the optical disk 2 to bring the base chassis 27 close to or separate the base chassis 27 from the optical disk 2. The sub-chassis 29 has a shape substantially identical with an external shape of the base chassis 27 and is made of a frame member of a substantially rectangular shape slightly larger than the base chassis 27. The sub-chassis 29 is coupled to the base chassis 27 to constitute the base unit 22 in conjunction with the base chassis 27. The sub-chassis 29 is provided along the side on which the guide shaft 35a is provided. A reinforcing chassis 44 that reinforces the sub-chassis 29 is integrally attached to the sub-chassis 29. The coupling pieces 45a and 45b, to which the dampers 28a and 28b are attached and which are coupled to the base chassis 27, are formed in the sub-chassis 29. The coupling piece 45a is provided in a position on one side over the longitudinal direction corresponding to the coupling piece 41a of the base chassis 27. The coupling piece 45b is protrudingly provided at an end on the disk mounting section 23 on the other side over the longitudinal direction corresponding to the coupling piece 41b of the base chassis 27.

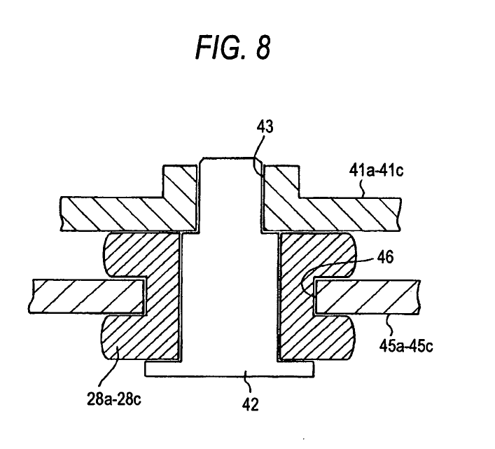

At an end on the opposite side of the disk mounting section 23 on the other side in the longitudinal direction, a coupling piece is not provided in the sub-chassis 29 and a coupling piece 45c is provided in the reinforcing chassis 44 fixed to the sub-chassis 29 in association with the coupling piece 41c of the base chassis 27. As shown in FIG. 8, through holes 46 connected to the respective through holes 43 of the respective coupling pieces 41a to 41c of the base chassis 27 are drilled in the respective coupling pieces 45a to 45c. The dampers 28a to 28c are attached to the coupling pieces 45a to 45c, respectively. The coupling pieces 45a to 45c are coupled to the coupling pieces 41a to 41c of the base chassis 27 via the dampers 28a to 28c. The stepped screws 42 are inserted through the respective through holes 43 and 46.

As shown in FIG. 7, the sub-chassis 29 has a first supporting shaft 47 located on the disk mounting section 23 side of the side opposed to the slider 122 described later and engaged with and supported by a first cam slit 130 of the slider 122, a second supporting shaft 48 located on the disk mounting section 23 side of the side opposed to a sub-slider 151 and engaged with and supported by a second cam slit 170 of the sub-slider 151, and a third supporting shaft 49 located on the front surface side of the side on the opposite side of the side opposed to the slider 122 and rotatably supported by a shaft hole 9 provided in the side plate section 6b of the main chassis 6.

Therefore, in the sub-chassis 29, the first supporting shaft 47 slides in the first cam slit 130 and the second supporting shaft 48 slides in the second cam slit 170 in association with the slide of the slider 122 and the sub-slider 151. Consequently, the disk mounting section 23 side of the sub-chassis 29 is rotated with the third supporting shaft 49 as a fulcrum to allow the base chassis 27 to rise and fall.

On the bottom surface of the bottom case 4, as shown in FIG. 3, a push-up pin 10 serving as chucking release means for removing the optical disk 2, which is mounted on the turntable 23a of the disk mounting section 23, from the turntable 23a when the base elevating mechanism 150 lowers the sub-chassis 29 and the base chassis 27 is provided. The push-up pin 10 is located near the disk mounting section 23 of the base unit 22, projected upward from the bottom surface of the bottom case 4, and inserted through a through hole 27c drilled in the decorative plate 30 to be exposed on the disk conveyance area.

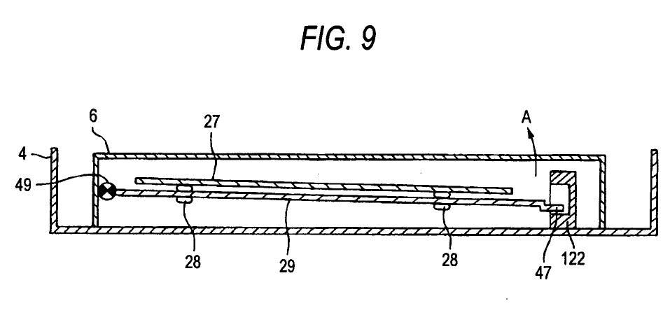

As shown in a schematic diagram in FIG. 9, the base unit 22 having such a constitution is lifted and lowered in an arrow A direction and a direction opposite to the arrow A direction. In this case, the base chassis 27 is supported by only the sub-chassis 29 via the respective dampers 28. Since all paths on which vibration from the outside is transmitted pass through the sub-chassis 29 attached with the dampers 28, resistance against shock is improved. Excess weight including that of the respective dampers 28 is not applied to the base chassis 27. In other words, total weight of an object to which shock is transmitted is small because the dampers are not provided. Thus, the shock resistance is further improved.

When the main chassis 6 is fixed to the bottom case 4, the main chassis 6 may be fixed via dampers. Specifically, as shown in FIG. 10, the dampers 28 are provided between the respective guide pieces 6f and the screw holes 4c of the bottom case 4. The main chassis 6 is fixed to the bottom case 4 by stepped screws.

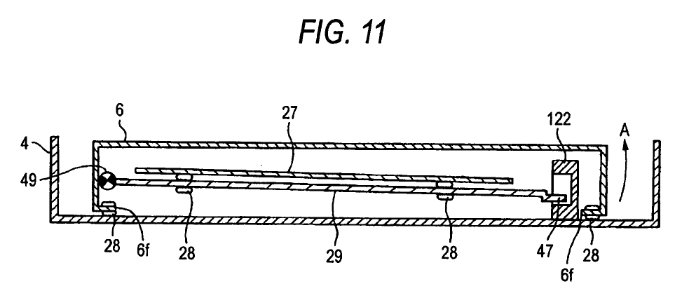

In the base unit 22 fixed in this way, as shown in a schematic diagram in FIG. 11, the sub-chassis 29 is supported by the main chassis 6 and the main chassis 6 is fixed to the bottom case 4 via the dampers 28. In this case, the base chassis 27 is supported only by the sub-chassis 29 via the dampers 28a to 28c and the sub-chassis 29 is supported by the main chassis 6. The main chassis 6 is fixed to the bottom case 4 via the dampers 28. Paths through which vibration from the outside is transmitted pass the main chassis 6 attached with the dampers 28 and the sub-chassis 29 attached with the dampers 28a to 28c. Since the vibration is transmitted via the dampers arranged at two stages, resistance against impact is further improved.

A cushioning material 39 may be provided between a substantially middle portion of the side plate section 6b of the main chassis 6 and the bottom case 4. The cushioning material 39 is formed of an elastic member such as a thin rubber piece in order to block, when the side plate section 6b and the bottom case 4 come into direct contact with each other because of amplitude of vibration due to impact, a path through which the impact is transmitted. An adhesive layer is formed on the entire surface of the cushioning material 39 and stuck to the side plate portion 6b of the main chassis 6.

Consequently, even when the clearance between the bottom case 4 and the main chassis 6 is narrowed and the main chassis 6 is connected to the inside of the bottom case 4 via the dampers 28, it is possible to prevent a situation in which the side plate section 6b of the main chassis 6 comes into contact with the bottom case 4 and disturbance is transmitted to the main chassis 6 and the base chassis 22 via the contact section.

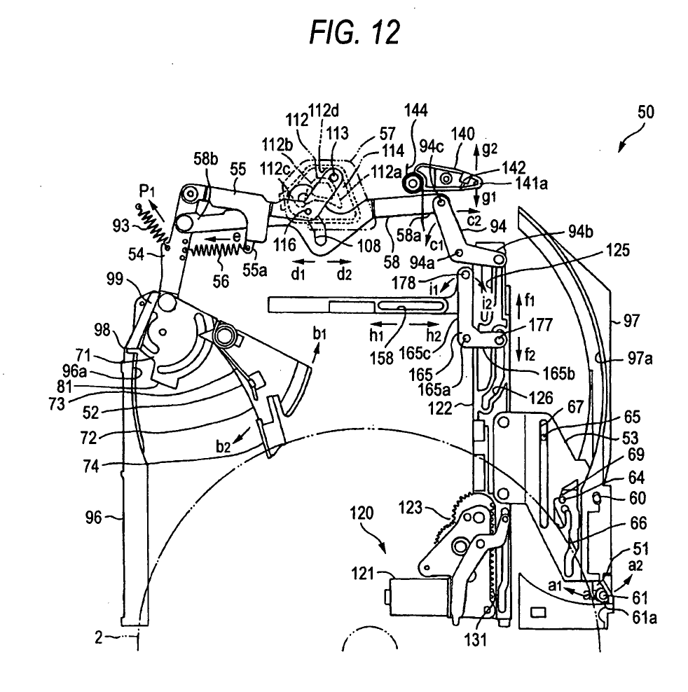

As shown in FIGS. 12 to 19, the disk drive device 1 includes the disk conveying mechanism 50 that conveys the optical disk 2 between a disk inserting and removing position where the optical disk 2 is inserted and ejected through the disk slot 19 and a disk mounting position where the optical disk 2 is mounted on the turntable 23a of the disk mounting section 23.

The disk conveying mechanism 50 has, as support members operated to move between the upper surface 6a of the main chassis 6 and the main surface opposed to the disk mounting section 23 of the top plate section 5a, the loading arm 51 and the eject arm 52 that are allowed to swing in a plane parallel to the main surface of the optical disk 2, the loading cam plate 53 that transmits a driving force from the driving mechanism 120 described later to the loading arm 51, the first link arm 54 that rotationally moves the eject arm 52 in an ejecting direction of the optical disk 2, the second link arm 55 coupled to the first link arm 54, a helical tension spring 56 suspended between the first and the second link arms 54 and 55, the loop cam 57 with which a guide projection 113 of the second link arm 55 is engaged to guide the second link arm 55, and the operation arm 58 that is coupled to the driving mechanism 120 to operate the first link arm 54 to move in a direction in which the eject arm 52 inserts or ejects the optical disk 2.

In the disk conveying mechanism 50, while the eject arm 52 is rotationally moved to a predetermined position according to the insertion of the optical disk 2, the first link arm 54 is rotationally moved in one direction by the eject arm 52 and the second link arm 55 is moved in a direction different from the rotationally moving direction of the first link arm 54 when the guide projection 113 formed at the tip of the second link arm 55 is guided by the loop cam 57. Thus, the eject arm 52 is rotationally moved in the inserting direction while being urged in the ejecting direction by the helical tension spring 56. On the other hand, when the optical disk 2 is ejected, the guide projection 113 of the second link arm 55 is guided by the loop cam 57 and the first and the second link arms 54 and 55 move close to each other. Thus, the helical tension spring 56 is not stretched and the disk conveying mechanism 50 rotationally moves the eject arm 52 with the operation arm 58 via the first link arm 54 to eject the optical disk 2 in a state in which an urging force in the ejecting direction does not work.

Consequently, when the optical disk 2 is inserted, in a process in which the optical disk 2 is inserted to the predetermined position by the user, it is possible to cause the urging force in the ejecting direction by the helical tension spring 56 to work. Thus, it is possible to prevent a situation in which the optical disk 2 is left as being incompletely inserted into the housing 3 when the insertion of the optical disk 2 by the user is stopped. When the optical disk 2 is ejected, the urging force in the ejecting direction by the helical tension spring 56 given to the eject arm 52 does not work. Thus, the eject arm 52 is rotationally moved according to the operation of the operation arm 58 subjected to the driving force of the driving mechanism 120. It is possible to stably eject, without relying on an elastic force, the optical disk 2 to a predetermined stop position where the center hole 2a of the optical disk 2 is ejected to the outside of the housing 3.

The respective members constituting the disk conveying mechanism 50 will be hereinafter explained in detail.

The loading arm 51 conveys the optical disk 2 onto the disk mounting section 23. The base end of the loading arm 1 is supported on the deck section 4a of the bottom case 4 to freely move rotationally further to the disk slot 19 side than the disk mounting section 23. The tip of the loading arm 51 is allowed to rotationally move in the arrow a₁ direction and an arrow a₂ direction in FIG. 12. Specifically, the loading arm 51 is made of a flat sheet metal. An insert-through section 60 is protrudingly provided at one end thereof. Since the insert-through section 60 is engaged with the deck section 4a, the loading arm 51 is supported to be rotationally movable on the deck section 4a in the arrow a₁ direction and the arrow a₂ direction in FIG. 12.

In the loading arm 51, a contact section 61 brought into contact with the outer circumference of the optical disk 2 inserted from the disk slot 19 is provided at the tip thereof to project upward. A small-diameter rotation roller 61a is rotatably attached to the contact section 61. The contact section 61 is made of resin softer than the optical disk 2. The center of the contact section 61 brought into contact with the outer circumference of the optical disk 2 inserted from the disk slot 19 is bent to the inner side and both the ends thereof are extended in diameter. Thus, the contact section 61 is formed in a substantial drum shape for regulating the movement in the height direction of the optical disk 2 as a flange section.

In the loading arm 51, a locking piece 63 is formed to rise near the insert-through section 60. The other end of a coil spring 62, one end of which is locked to a right guide wall 97, is locked to the locking piece 63 (see FIG. 6). Consequently, the loading arm 51 is typically urged to rotationally move in the arrow a₁ direction in FIG. 12 by an urging force of the coil spring 62 with the insert-through section 60 as a fulcrum to urge the optical disk 2 to rotationally move from the disk slot 19 side to the disk mounting section 23 side.

Moreover, in the loading arm 51, an engaging projection 64 inserted through and engaged with a first cam groove 66 of the loading cam plate 53 described later is protrudingly provided. When the engaging projection 64 moves along the first cam groove 66 of the loading cam plate 53, the loading arm 51 is rotationally moved while regulating the urging force of the coil spring 62.

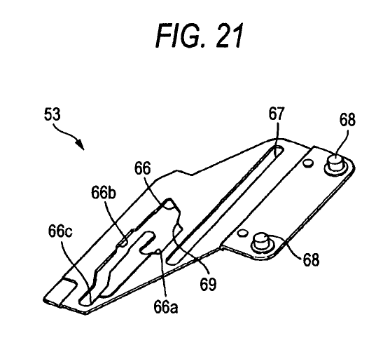

The loading cam plate 53 that rotationally moves the loading arm 51 is made of a flat sheet metal. The loading cam plate 53 is engaged with the slider 122 of the driving mechanism 120 described later to move back and forth on the deck section 4a according to the movement of the slider 122. The loading cam plate 53 is superimposed on the loading arm 51 supported on the deck section 4a and the engaging projection 64 is inserted through the loading cam plate 53, whereby the loading cam plate 53 regulates the rotational movement of the loading arm 51. The loading cam plate 53 has formed thereon, as shown in FIG. 21, the first cam groove 66 through which the engaging projection 64 protrudingly provided in the loading arm 51 is inserted, a second cam groove 67 through which a guide projection 65 protrudingly provided in the deck section 4a is inserted, and a pair of engaging protrusions 68, 68 that engage with the slider 122.

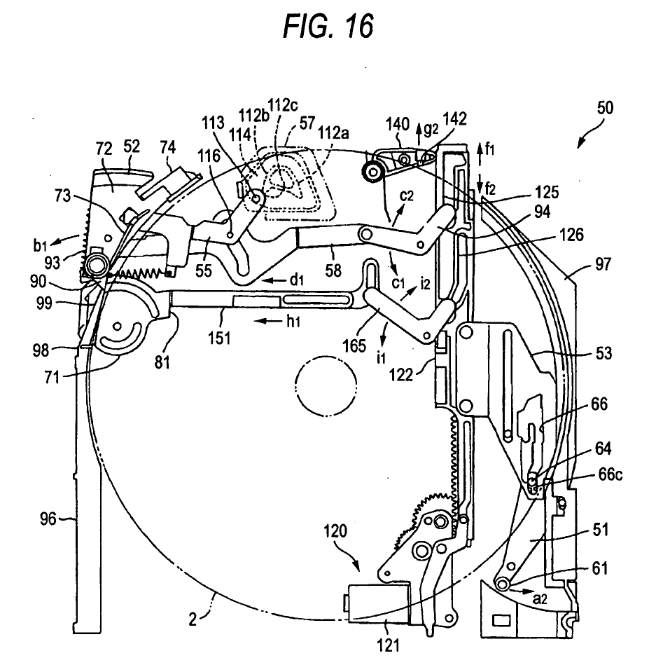

When the engaging projection 64 is slidingly moved, the first cam groove 66 regulates the rotational movement of the loading arm 51 urged in the loading direction of the optical disk 2 by the coil spring 62. The first cam groove 66 includes a first guide section 66a that regulates the engaging projection 64 to regulate the rotational movement of the loading arm 51 in the arrow a₁ direction in FIG. 12, which is the loading direction of the optical disk 2, a second guide section 66b that is provided adjacent to the first guide section 66a and rotationally moves the loading arm 51 continuously in the loading direction of the optical disk 2, and a third guide section 66c that is formed continuously from the second guide section 66b and guides the engaging projection 64 to rotationally move in an arrow a₂ in FIG. 16 in which the loading arm 51 separates from the outer circumference of the optical disk 2 mounted on the disk mounting section 23.

When the loading cam plate 53 is moved backward in the housing 3, the engaging projection 64 moves along the second guide section 66b. Thus, the loading arm 51 subjected to the urging force of the coil spring 62 is rotationally moved in the arrow a₁ direction in FIG. 12, which is the loading direction of the optical disk 2, to press the optical disk 2 to the disk mounting section 23 side. When the optical disk 2 is mounted on the disk mounting section 23, the engaging projection 64 is moved along the third guide section 66c. Thus, the loading arm 51 is rotationally moved in the arrow a₂ direction in FIG. 16 against the urging force of the coil spring 62. The contact section 61 of the loading arm 51 separates from the outer circumference of the optical disk 2 and allows the optical disk 2 to rotate.

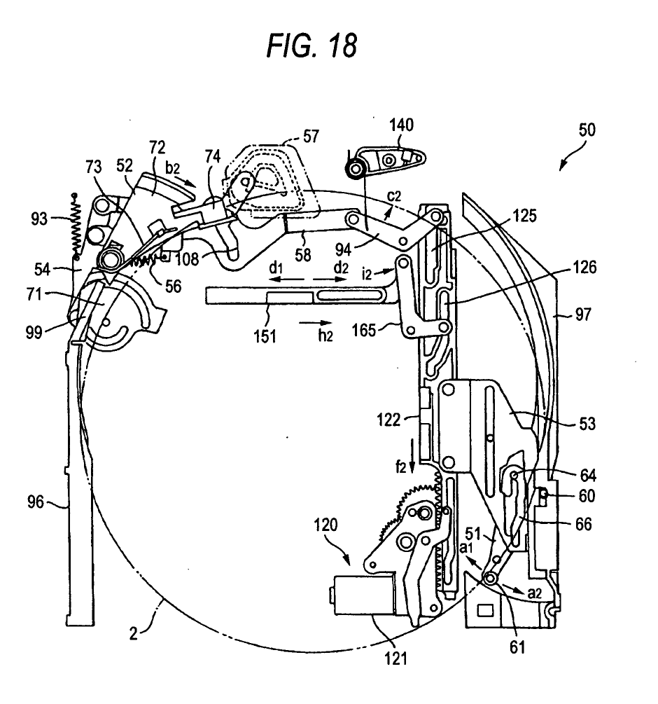

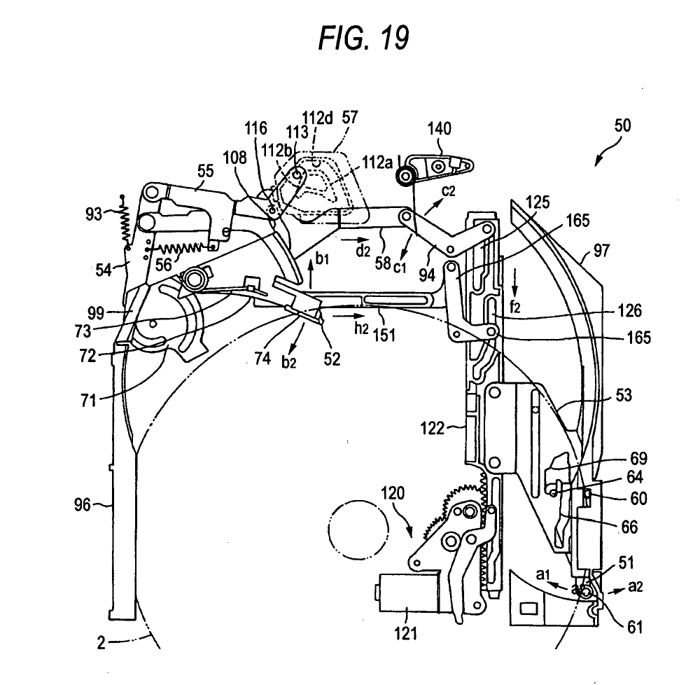

When the optical disk 2 is ejected, the loading cam plate 53 is moved backward as the slider 122 is moved forward. Thus, the engaging projection 64 moves from the second guide section 66b to the first guide section 66a and the loading arm 51 is rotationally moved in the arrow a₁ direction in FIGS. 18 and 19 to be brought into contact with the optical disk 2. In this case, the optical disk 2 is ejected while being pressed in the ejecting direction by the eject arm 52 subjected to the driving force of the driving mechanism 120 and being urged in the inserting direction by the loading arm 51 urged by the coil spring 62. Consequently, the disk conveying mechanism 50 pushes out the optical disk 2 to a predetermined ejection position while holding the optical disk 2 between the loading arm 51 and the eject arm 52. Thus, the loading arm 51 can prevent the optical disk 2 from suddenly springing out.

When the ejection of the optical disk 2 ends, the engaging projection 64 is locked by a projection 69 formed in the first cam groove 66 of the loading cam plate 53. Thus, the rotational movement in the a₁ direction of the loading arm 51 is regulated. The loading arm 51 is held in a position retracted from the disk conveyance area and stands by for insertion of the optical disk 2.

The second cam groove 67 is inserted through the guide projection 65 protrudingly provided in the deck section 4a to guide the movement of the loading cam plate 53. The second cam groove 67 is a linear cam groove parallel to a moving direction of the slider 122. When the guide projection 65 slides according to the movement of the slider 122, the second cam groove 67 guides the loading cam plate 53 in the moving direction of the slider 122.

The pair of engaging protrusions 68, 68 that engage with the slider 122 are formed on one side of the loading cam plate 53 to be spaced apart from each other. The engaging protrusions 68, 68 are protrudingly provided downward and projected to the bottom surface side of the bottom case 4 to be engaged with engaging recesses 127, 127 of the slider 122 disposed along the side of the bottom case 4. Consequently, the loading cam plate 53 and the slider 122 are integrated. The loading cam plate 53 is slid according to the movement of the slider 122.

The one side of the loading cam plate 53, on which such engaging protrusions 68, 68 are formed, and the other side of the loading cam plate 53 are slidably inserted through a clearance provided between the right guide wall 97 and the deck section 4a. Consequently, the loading cam plate 53 is prevented from lifting from the deck section 4a.

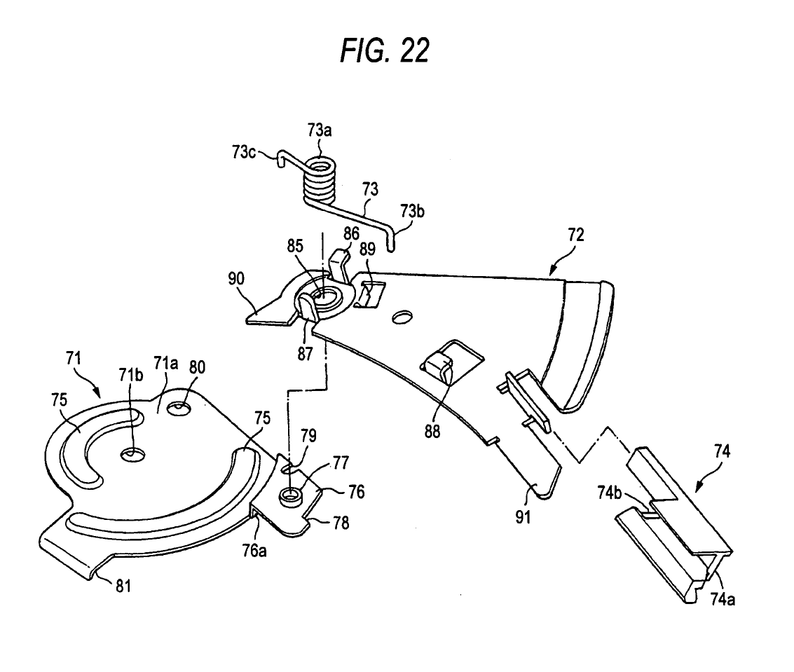

The eject arm 52 that ejects the optical disk 2 to the outside of the disk slot 19 from the disk mounting section 23 is disposed further on the rear surface side of the housing 3 than the disk mounting section 23 on the side opposite to the side on which the loading arm 51 is formed. The eject arm 52 is rotationally moved, while being operated by the first and the second link arms 54 and 55 and the operation arm 58 described later, in an arrow b₁ direction in FIG. 12 in which the optical disk 2 is conveyed to the disk mounting section 23 side and an arrow b₂ direction in FIG. 12 in which the optical disk 2 is ejected to the disk slot 19 side. As shown in FIG. 22, the eject arm 52 includes a rotation supporting member 71 supported by the main chassis 6 to freely rotate, a push-out arm 72 that is engaged with the rotation supporting member 71 to freely move rotationally and pushes out the optical disk 2, a coil spring 73 that urges the push-out arm 72 in the ejecting direction of the optical disk 2, and the contact member 74 that is attached to the tip of the push-out arm 72 and brought into contact with the side of the optical disk 2.

The rotation supporting member 71 is formed of a substantially circular sheet metal. The rotation supporting member 71 is attached to the upper surface 6a of the main chassis 6 to freely rotate on the opposite side of the disk conveyance area of the upper surface 6a of the main chassis 6. An attachment opening 71b for attaching the rotation supporting member 71 to the main chassis 6 is drilled substantially in the center of a main surface 71a of the rotation supporting member 71. On the main surface 71a of the rotation supporting member 71, a sliding contact section 75 of a convex shape that is brought into sliding contact with the main chassis 6 is formed to swell. Since the sliding contact section 75 comes into sliding contact with the main chassis 6, the rotation supporting member 71 is smoothly rotated.

In the rotation supporting member 71, an engaging piece 76 with which the push-out arm 72 and the coil spring 73 are engaged is formed. The engaging piece 76 is formed to be bent from the tip of a vertical wall 76a vertically provided from the main surface 71a. Thus, the engaging piece 76 is provided above the main surface 71a and projected further to the upper surface 6a side than the eject arm opening 6d of the main chassis 6. The engaging piece 76 has formed therein an engaging section 77 of a cylindrical shape that is inserted through an opening 85 of the push-out arm 72 and through which the coil spring 73 is inserted, a rotational-movement regulating section 78 that regulates the rotational movement of the push-out arm 72 when a locking piece 89 protrudingly provided from the push-out arm 72 is locked thereto, and a locking recess 79 to which one arm 73c of the coil spring 73 is locked.

On the main surface 71a of the rotation supporting member 71, an engaging hole 80 with which the first link arm 54 described later is engaged to freely move rotationally is formed. In the rotation supporting member 71, a bent piece 81 is formed from one side of the main surface 71a. The bent piece 81 is bent downward from the main surface 71a to serve as a contact piece that is brought into contact with the sub-slider 151 of the base elevating mechanism 150 described later. When the bent piece 81 is rotated in the arrow b₁ direction in FIG. 12, in which the optical disk 2 is conveyed to the disk mounting section 23 side, according to the insertion of the optical disk 2, the bent piece 81 turns on a first switch SW1 mounted on the circuit board 59. Consequently, the disk drive device 1 can detect that the eject arm 52 pressed by the optical disk 2 is rotationally moved to the rear surface side of the housing 3 and can take timing for driving the driving mechanism 120.

The push-out arm 72 engaged with the engaging piece 76 to freely move rotationally is made of a flat sheet metal. The push-out arm 72 has the opening 85 that is formed at one end and through which the engaging section 77 of the engaging piece 76 is inserted to be engaged therewith, first to third locking projected pieces 86 to 88 to which the coil spring 73 is locked, the locking piece 89 locked to the rotational-movement regulating section 78 of the rotation supporting member 71, a pressing piece 90 that presses a left guide wall 96, which guides centering of the optical disk 2, and separates the left guide wall 96 from the optical disk 2, and an attachment section 91 that is formed at the other end and to which the contact member 74 is attached. When the engaging section 77 of the rotation supporting member 71 is inserted through the opening 85, the push-out arm 72 is engaged with the rotation supporting member 71 to freely move rotationally. The first and the second locking projected pieces 86 and 87 vertically provided around the opening 85 are inserted through a cylindrical section 73a of the coil spring 73 to hold the coil spring 73. One arm 73b of the coil spring 73 is locked to the third locking projected piece 88. The other arm 73c of the coil spring 73 is locked to the engaging recess 79 of the rotation supporting member 71. Consequently, the push-out arm 72 urged to rotationally move to the disk slot 19 side with a predetermined spring force with the engaging section 77 of the rotation supporting member 71 as a fulcrum.

The locking piece 89 is formed to be bent downward from the vicinity of the opening 85. When the push-out arm 72 rotationally moves, the locking piece 89 comes into contact with the rotational-movement regulating section 78 of the rotation supporting member 71 and regulates the rotational movement of the push-out arm 72 urged to the disk slot 19 side. The pressing piece 90 presses the left guide wall 96, which is urged to the conveyance area of the optical disk 2 and guides centering of the optical disk 2, to retract the left guide wall 96 from the optical disk 2 at the time of recording and/or reproduction.

The contact member 74 attached to the attachment section 91 of the push-out arm 72 is made of a resin molded product softer than the optical disk 2. The contact member 74 has a disk receiving section 74a of a concave shape brought into contact with the outer circumference of the optical disk 2, a through hole 74b through which the attachment section 91 of the push-out arm 72 is inserted, and a regulating section 74c that regulates, when a small-diameter disk is inserted by mistake, the insertion into the housing 3. When the attachment section 91 is inserted through the through hole 74b, the contact member 74 is integrated with the push-out arm 72. In the contact member 74, a stopper 100 that prevents misinsertion of a small-diameter optical disk 101 may be formed. The stopper 100 will be described later.

In such an eject arm 52, the rotation supporting member 71 and the push-out arm 72 are engaged with each other to freely move rotationally and the push-out arm 72 is urged to rotationally move to the disk slot 19 side with a predetermined spring force by the coil spring 73. It is assumed that the eject arm 52 is operated to rotationally move in the arrow b₂ direction in FIG. 19, in which the optical disk 2 is ejected to the outside of the housing 3, by the first link arm 54 and the operation arm 58 subjected to the driving force of the driving mechanism 120 described later. Then, even if a force in the arrow b₁ direction acts because of, for example, an obstacle on the conveyance area of the optical disk 2, the push-out arm 72 subjected to a force in a direction opposite to the ejecting direction of the optical disk 2 is rotationally moved in the arrow b₁ direction with the engaging section 77 of the rotation supporting member 71 as a fulcrum against the urging force of the coil spring 73. Consequently, a situation in which the driving force for rotationally moving the eject arm 52 in the b₂ direction and the force acting in the direction opposite to the driving force are opposed to each other is prevented. Therefore, excess loads are not applied to the motor and the like of the driving mechanism 120 that drives the first link arm 54 and the operation arm 58 to rotationally move the eject arm 52 in the arrow b₂ direction in FIG. 19. It is possible to prevent the optical disk 2 from being broken by the urging force in the ejecting direction applied by the eject arm 52 and the force acting in the opposite direction.

The first link arm 54 engaged with the rotation supporting member 71 of the eject arm 52 to freely move rotationally is operated by the operation arm 58 described later to rotationally move the eject arm 52 in the arrow b₁ direction or the arrow b₂ direction in FIG. 12, which is the inserting direction or the ejecting direction of the optical disk 2. The first link arm 54 is made of a metal plate formed in a substantially rectangular shape. One end in the longitudinal direction of the first link arm 54 is engaged with the engaging hole 80 of the rotation supporting member 71 to freely rotate. The other end in the longitudinal direction is engaged with the second link arm 55 to freely rotate. The other end of an urging coil spring 93, the other end 58b of the operation arm 58, and one end of the helical tension spring 56 suspended between the first link arm 54 and the second link arm 55 are attached to substantially the middle in the longitudinal direction.

One end of the urging coil spring 93 is locked to a locking section provided on the upper surface 6a of the main chassis 6. The other end thereof is attached to substantially the middle of the first link arm 54. Consequently, the urging coil spring 93 lifts the first and the second link arms 54 and 55 in a p₁ direction in FIG. 12 and turns the guide projection 113 of the second link arm 55 around the loop cam 57.

The second link arm 55 engaged with the other end of the first link arm 54 to freely move rotationally is made of a long sheet metal. At one end of the second link arm 55, the guide projection 113 is protrudingly provided toward a guide groove 114 of the loop cam 57. The guide projection 113 is engaged with the guide groove 114 to be guided by a loading guide wall 112a and an eject guide wall 112b and control a distance between the first link arm 54 and the second link arm 55. The second link arm 55 is provided with a spring locking piece 55a in the middle in the longitudinal direction thereof. One end of the helical tension spring 56 suspended between the second link arm 55 and the first link arm 54 is locked to the spring locking piece 55a.

In the second link arm 55, an engaging projection 116 that is engaged with a cam groove 108 formed in the operation arm 58 described later is formed. When the engaging projection 116 is engaged with the cam groove 108, the second link arm 55 can rotationally move the eject arm 52 according to the movement of the slider 122. Thus, the disk conveying mechanism 50 can stably eject the optical disk 2 to the predetermined ejection position.

In other words, during the ejection of the optical disk 2, when the panel curtains provided in the disk slot 19 of the front panel 18 come into sliding contact with the optical disk 2 and loads are applied to the panel curtains, the rotation supporting member 71 of the eject arm 52 and the first link arm 54 are urged in the b₁ direction. When the second link arm 55 and the operation arm 58 are not engaged, even if the operation arm 58 is moved in a d₂ direction according to slide in an f₂ direction of the slider 122, the first link arm 54 only rotationally moves in the d₂ direction with respect to the rotation supporting member 71 with the engaging hole 80 as a fulcrum. It is difficult to rotationally move the eject arm 52 in the b₂ direction. The second link arm 55 only rotationally moves with respect to the first link arm 54.

On the other hand, when the second link arm 55 is engaged with the operation arm 58, according to slide in the d₂ direction of the operation arm 58, the engaging projection 116 is brought into abutment against the sidewall of the cam groove 108 to make it difficult for the second link arm 55 to freely move rotationally with respect to the first link arm 54. In other words, when the engaging projection 116 of the second link arm 55 is brought into contact with the sidewall of the cam groove 108, the rotational movement in the d₂ direction of the first link arm 54 is regulated. Therefore, even when the eject arm 52 is urged in the b₁ direction during the ejection of the optical disk 2, when the operation arm 58 is moved in the d₂ direction, the first link arm 54 is moved in the d₂ direction against the urging force in the b₁ direction to rotationally move the eject arm 52 in the b₂ direction. Consequently, the rotational movement of the eject arm 52 in the b₂ direction corresponding to an amount of slide in the f₂ direction of the slider 122 is realized. Thus, the disk conveying mechanism 50 can surely eject the optical disk 2 to the predetermined ejection position.

As described above, the loop cam 57 that guides the movement of the guide projection 113 of the second link arm 55 is locked to the locking hole drilled in the upper surface 6a of the main chassis 6. In the loop cam 57, a cam wall 112 of an annular shape is vertically provided toward the bottom case 4 side. The guide projection 113 of the second link arm 55 turns around the cam wall 112 from the loading to the ejection of the optical disk 2. The cam wall 112 has formed therein the loading guide wall 112a on which the guide projection 113 slides at the time of loading of the optical disk 2, the eject guide wall 112b on which the guide projection 113 slides at the time of ejection of the optical disk 2, and a protrusion 112c that prevents reverse movement of the guide projection 113 between the loading guide wall 112a and the eject guide wall 112b. The loading guide wall 112a, the eject guide wall 112b, and the protrusion 112c are surrounded by an outer periphery 112d to form a guide groove 114 in which the guide projection 113 moves.

The operation arm 58 that is coupled to the first link arm 54 and the driving mechanism 120 and operates the eject arm 52 is made of a long metal plate. The cam groove 108, through which the engaging projection 116 formed in the second link arm 55 is inserted, is formed in the center in the longitudinal direction of the operation arm 58. One end 58a in the longitudinal direction of the operation arm 58 is engaged with a third link arm 94 coupled to the slider 122 of the driving mechanism 120. The other end 58b is engaged with the first link arm 54.

As described above, the cam groove 108 is engaged with the engaging projection 116 of the second link arm 55 to rotationally move the eject arm 52 according to a slide action of the slider 122. The cam groove 108 is formed in a long hole shape to allow the engaging projection 116 to move when the second link arm 55 turns around the loop cam 57. The cam groove 108 is formed over a direction substantially orthogonal to an arrow d₁ direction and the arrow d₂ direction in FIG. 12, which are moving directions of the operation arm 58. Consequently, since the engaging projection 116 is brought into contact with the sidewall, the cam groove 108 can regulate the rotational movement of the second link arm 55 and can regulate the rotational movement in the d₂ direction of the first link arm 54.

When the slider 122 is operated to slide, the operation arm 58 is moved in the arrow d₁ direction and the arrow d₂ direction in FIG. 12, which are substantially a left to right direction, via the third link arm 94 to operate the first link arm 54 and the eject arm 52 to rotationally move. Specifically, when the operation arm 58 is moved in the arrow d₁ direction in FIG. 12 by the third link arm 94, the operation arm 58 presses the first link arm 54 in the same direction to rotationally move the eject arm 52 in the arrow b₁ direction in FIG. 12, which is the inserting direction of the optical disk 2. When the operation arm 58 is moved in the arrow d₂ direction in FIG. 12 by the third link arm 94, the operation arm 58 moves the first link arm 54 in the same direction to rotationally move the eject arm 52 in the arrow b₂ direction in FIG. 12, which is the ejecting direction of the optical disk 2.

The third link arm 94 engaged with one end 58a of the operation arm 58 to freely move rotationally is made of a metal plate of a substantially V shape. The third link arm 94 has a bent section 94a attached to the main chassis 6 to freely move rotationally. Thus, the third link arm 94 is supported to freely move rotationally in an arrow c₁ direction and an arrow c₂ direction in FIG. 12. In the third link arm 94, an engaging projection 109 formed at one end 94b extended from the bent section 94a is engaged with the slider 122 and the other end 94c is engaged with the operation arm 58 to freely rotate. Consequently, when the slider 122 is subjected to the driving force of the driving motor 121 of the driving mechanism 120 to be conveyed in an arrow f₁ direction in FIG. 12, the third link arm 94 is guided by a first guide groove 125 formed in the slider 122 to be rotationally moved in the arrow c₁ direction in FIG. 12 and moves the operation arm 58 in the d₁ direction in the figure.

When the slider 122 is conveyed in the arrow f₂ direction in FIG. 12, the third link arm 94 is guided by the first guide groove 125 to be rotationally moved in the arrow c₂ direction in the figure and moves the operation arm 58 in the arrow d₂ direction in the figure.

The left and the right guide walls 96 and 97 disposed on both the left and the right sides of the disk conveyance area guide centering of the optical disk 2 when the side of the optical disk 2 is slid on the guide walls. The left and the right guide walls 96 and 97 are formed of synthetic resin or the like softer than the optical disk 2. The right guide wall 97 is disposed on the deck section 4a and the left guide wall 96 is disposed on the main chassis 6. Both the right guide wall 97 and the left guide wall 96 are fixed by screws, adhesive tapes, or the like.

In the left and the right guide walls 96 and 97, sidewalls 96a and 97a of an arcuate shape corresponding to the shape of the optical disk 2 are vertically provided. The sidewalls 96a and 97a are provided in positions a predetermined clearance apart from the side of the optical disk 2 conveyed to a centering position of the optical disk 2. The sidewalls 96a and 97a do not come into contact with the optical disk 2 driven to rotate. The tip of the sidewall 96a formed in the left guide wall 96 on the opposite side of the disk slot 19 is formed as a centering guide piece 99 formed to freely swing over the inside and the outside of the disk conveyance area via a hinge section 98. The centering guide piece 99 is urged by a leaf spring 95 (see FIG. 6) to be bend to the disk conveyance area side and make it possible to bring the side of the optical disk 2 into contact therewith. Consequently, the optical disk 2 is urged in a centering direction of the optical disk 2 by the centering guide piece 99. When the optical disk 2 is inserted deep into the housing and the eject arm 52 is rotationally moved in the b₁ direction, the centering guide piece 99 is pressed by the pressing piece 90 formed in the push-out arm 72 to be retracted from the disk conveyance area. During a recording or reproduction operation, the centering guide piece 99 is held in a position spaced apart from the side of the optical disk 2.

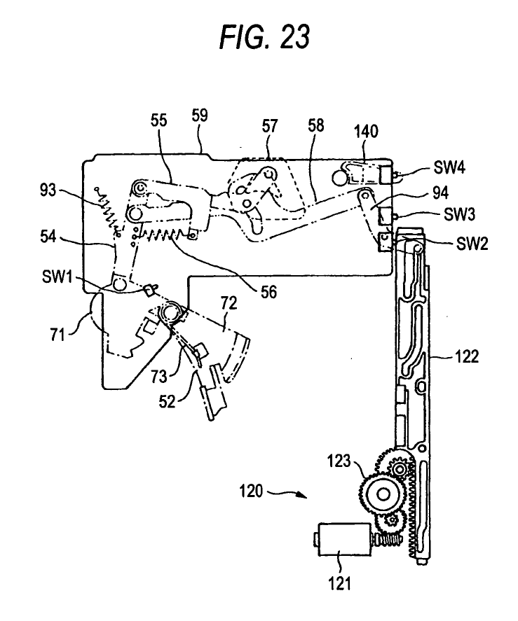

Operations from the insertion to the ejection of the optical disk 2 by the disk conveying mechanism 50 constituted as described above will be explained. A conveyance state of the optical disk 2 is monitored by detecting depression states of first to fourth switches SW1 to SW4 mounted on the circuit board 59. As shown in FIG. 23, the first switch SW1 is disposed in a rotation area of the rotation supporting member 71 of the eject arm 52. When the first switch SW1 is depressed by the rotation supporting member 71 according to the rotational movement of the eject arm 52, H and L of the first switch SW1 are switched (a state in which the switch is depressed is referred to as L and a state in which the switch is not depressed is referred to as H). As shown in FIG. 23, the second to the fourth switches SW2 to SW4 are arranged on a moving area of the slider 122. When the slider 122 is slid in the f₁ direction or the f₂ direction, H and L of the switches are sequentially switched.

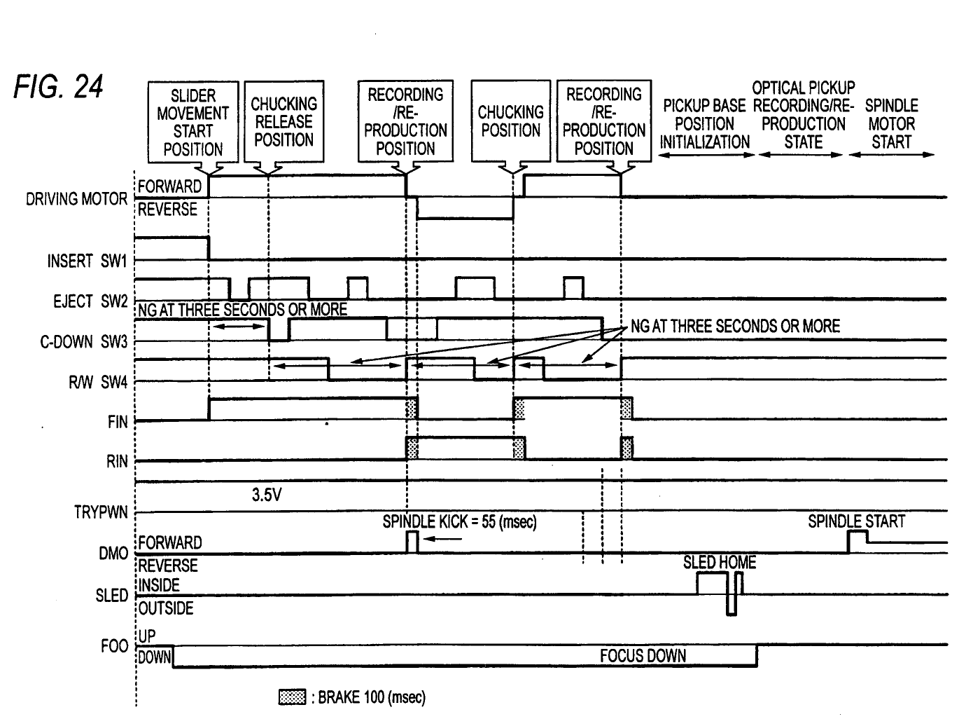

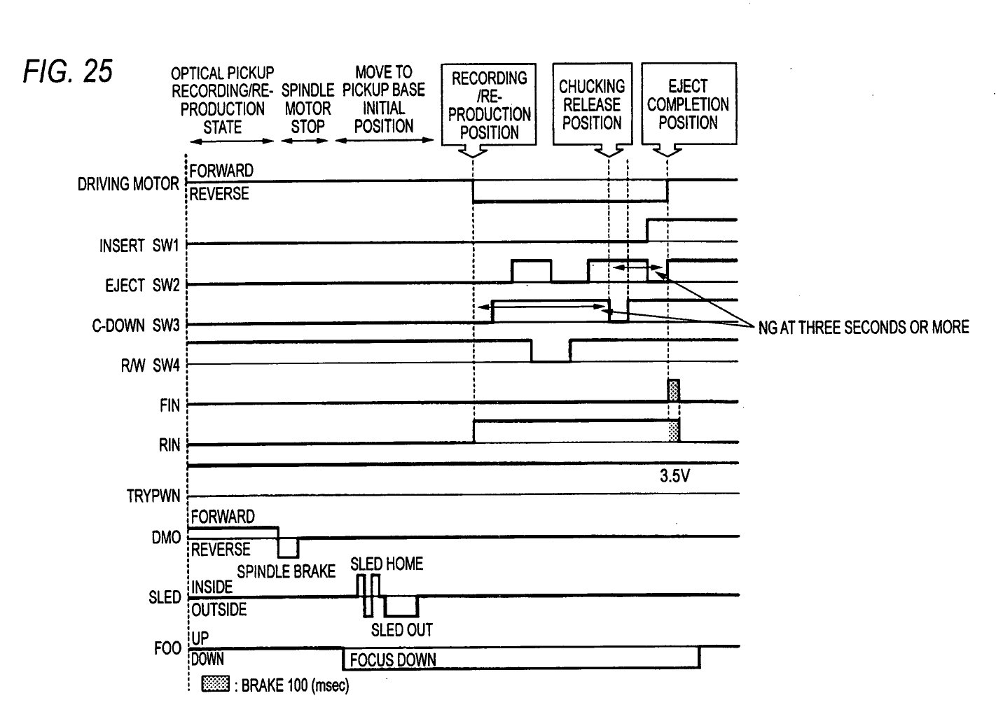

The disk drive device 1 monitors depression states of such first to fourth switches SW1 to SW4 and time of the depression with a microcomputer to detect a conveyance state of the optical disk 2 and drives the driving motor 121, the spindle motor 24a, the displacement driving mechanism 36, the optical pickup 25, and the like. Specifically, the disk drive device 1 detects a conveyance state of the optical disk 2 and output timing of the various motors and the like in accordance with timing chart shown in FIGS. 24 and 25.

Before the insertion of the optical disk 2, as shown in FIG. 12, the slider 122 is slid in the arrow f₂ direction in the figure on the disk slot 19 side. Consequently, the loading arm 51 is rotationally moved to be held in a position where the engaging projection 64 is engaged with the projection 69 of the loading cam plate 53 and the contact section 61 is retracted from the conveyance area of the optical disk 2. The third link arm 94 engaged with the slider 122 is rotationally moved in the arrow c₂ direction in FIG. 12. Consequently, the eject arm 52 operated to rotationally move by the operation arm 58 and the first link arm 54 is urged to rotationally move in the arrow b₂ direction in FIG. 12. When the slider 122 is slid in the f₂ direction, the sub-slider 151 is slid in an arrow h₂ direction in the figure. Consequently, the sub-chassis 29 constituting the base unit 22 is lowered to the bottom case 4 side and retracted from the conveyance area of the optical disk 2.

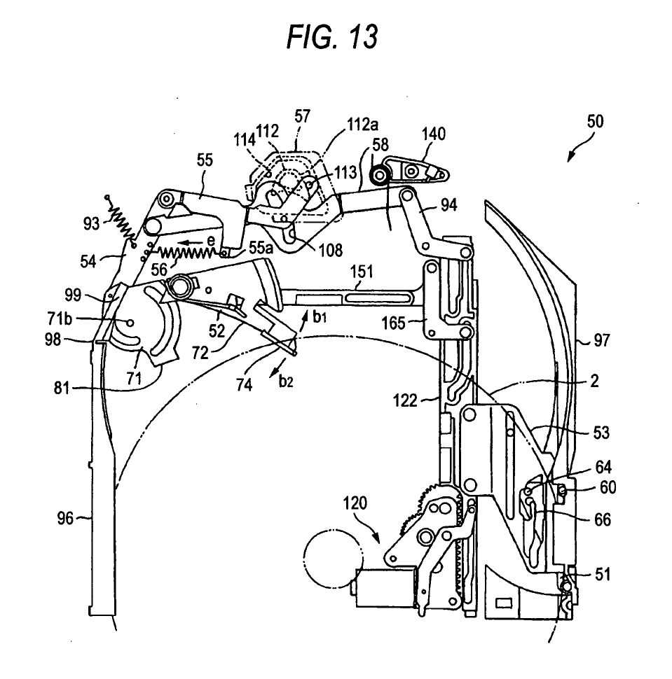

When the optical disk 2 is inserted from the disk slot 19 by the user, the contact section 61 of the eject arm 52 is pressed against the insertion end face of the optical disk 2 and, as shown in FIG. 13, the eject arm 52 is rotationally moved in the arrow b₁ direction in FIG. 13. In this case, since the rotation supporting member 71 is rotated in the b₁ direction with the attachment opening 71b as a fulcrum, one end side of the first link arm 54 engaged with the rotation supporting member 71 is also moved to the left guide wall 96 side. On the other hand, in the second link arm 55 engaged with the first link arm 54, the guide projection 113 engaged with the guide groove 114 of the loop cam 57 is moved along the loading guide wall 112a. Since the loading guide wall 112a of the loop cam 57 is extended toward the right guide wall 97 side, the second link arm 55 is guided by the loading guide wall 112a to separate from the first link arm 54. Therefore, since the helical tension spring 56 suspended between the first link arm 54 and the second link arm 55 is stretched, the first link arm 54 and the second link arm 55 are urged in a direction in which the link arms move close to each other. The guide projection 113 is set in contact with the loading guide wall 112a in the second link arm 55. Thus, a force applied to the spring locking section 55a of the second link arm 55, that is, an urging force in a direction opposite to the rotating direction of the rotation supporting member 71 acts on the first link arm 54. Therefore, the eject arm 52 is urged in the arrow b₂ direction in FIG. 13, which is the ejecting direction of the optical disk 2 .

Therefore, the optical disk 2 is inserted against the urging force in the ejecting direction acting on the eject arm 52. Thus, even when the insertion of the optical disk 2 is stopped in the middle by the user, since the optical disk 2 is ejected to the outside of the housing 3, it is possible to prevent a situation in which the optical disk 2 remains in the housing 3 in an incompletely ejected state.

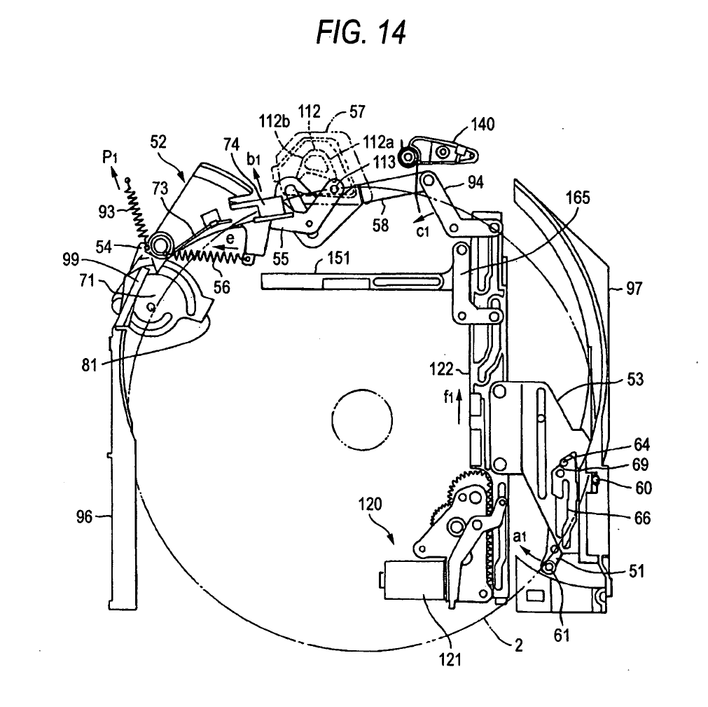

When the optical disk 2 is inserted by the user against such an urging force and the eject arm 52 is rotationally moved to a predetermined angle, the first switch SW1 disposed on the circuit board 59 is depressed by the bent piece 81 of the rotation supporting member 71 to start the driving mechanisms 120. In this case, depression states of the first to the fourth switches SW1 to SW4 are L, H, H, and H in order and detected by the microcomputer for the disk drive device 1 (a state in which the switch is depressed is referred to as L and a state in which the switch is not depressed is referred to as H). In the driving mechanism 120, the slider 122 is subjected to the driving force of the driving motor 121 and slid in the arrow f₁ direction in FIG. 14. Consequently, the loading cam plate 53 is also slid in the same direction together with the slider 122. Thus, the loading arm 51 regulated not to rotationally move by the first cam groove 66 is urged by the coil spring 62 to rotationally move in the arrow a₁ direction in FIG. 14. The contact section 61 comes into contact with the side in the rear part of the optical disk 2 to load the optical disk 2.

When the eject arm 52 is rotationally moved to a start position of the driving mechanism 120, the guide projection 113 of the second link arm 55 moves from the loading guide wall 112a to the eject guide wall 112b of the loop cam 57. Thus, the first link arm 54 and the second link arm 55 are brought close to each other and the coil spring 56 contracts. Therefore, the urging force in the b₂ direction acting on the eject arm 52 does not work any more. When the first link arm 54 is urged in the P1 direction by the third link arm 94, the second link arm 55 is moved in the same direction. Thus, the guide projection 113 is moved from the loading guide wall 112a to the eject guide wall 112b side to be located near the protrusion 112c.

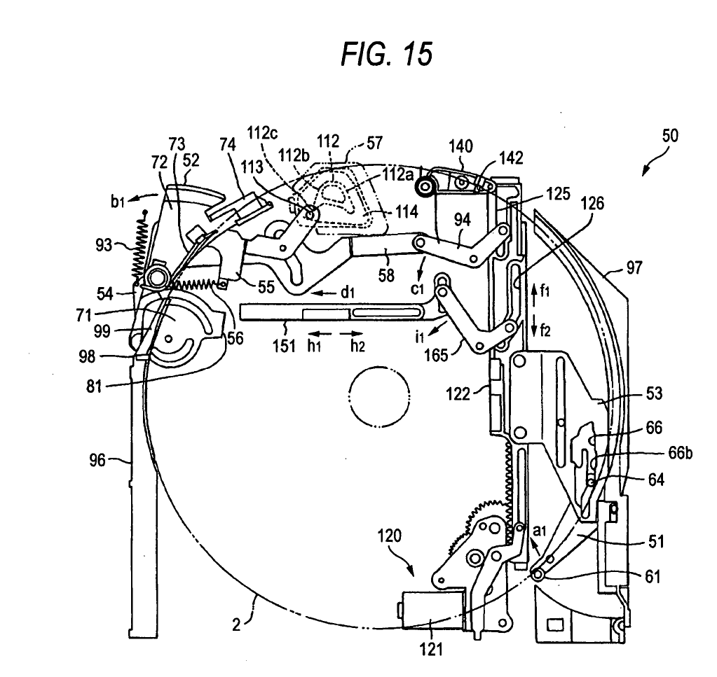

When the slider 122 is further slid in the f₁ direction, as shown in FIG. 15, the engaging projection 64 moves in the first cam groove 66 of the loading cam plate 53 from the first guide section 66a to the second guide section 66b. According to the movement, the loading arm 51 is rotationally moved in the arrow a₁ direction in the figure. Thus, the optical disk 2 is conveyed onto the disk mounting section 23. In this case, depression states of the first to the fourth switches SW1 to SW4 are detected as L, H, L, and H in order. Thus, it is seen that the base unit 22 is lowered to a chucking release position and it is possible to safely convey the optical disk 2.

The optical disk 2 is loaded by the loading arm 51, guided by the left and the right guide walls 96 and 97, and brought into contact with a stop lever 140 to be centered on the disk mounting section 23.

The third link arm 94 is guided by the first guide groove 125 of the slider 122 to be rotationally moved in the arrow c₁ direction in FIG. 15. The operation arm 58 engaged with the third link arm 94 moves in the arrow d₁ direction in the figure. Therefore, the first link arm 54 engaged with the other end 58b of the operation arm 58 is pressed by the operation arm 58 to further move to the left guide wall 96 side. When the first link arm 54 is moved by the operation arm 58, since the rotation supporting member 71 is rotated in the arrow b₁ direction in the figure, the push-out arm 72 is rotationally moved in the same direction. In this case, the pressing piece 90 formed in the push-out arm 72 presses the centering guide piece 99 of the left guide wall 96 projected onto the disk conveyance area and separates the centering guide piece 99 from the side of the optical disk 2.

In this case, since a coupling arm 165 engaged with the slider 122 is rotationally moved, the sub-slider 151 is slid in an arrow h₁ direction in the figure and the base unit 22 is lifted to a chucking position. Consequently, the periphery of the center hole 2a of the optical disk 2 conveyed to the centering position is held by the turntable 23a and the contact projection 8 formed around the opening 7 of the top plate section 5a and is chucked on the turntable 23a.

In this case, depression states of the first to the fourth switches SW1 to SW4 are detected as L, L, H, and H in order. Thus, it is seen that the base unit 22 is lifted to the chucking position and the optical disk 2 is chucked on the turntable 23a. In a loading process for the optical disk 2 of the disk drive device 1, after the optical disk 2 is chucked on the turntable 23a, the spindle motor 24a is driven to rotate the optical disk 2 by half and the driving motor 121 is reversely rotated to lift the base unit 22 to the chucking position again. This is so-called double chucking (see FIG. 24). Consequently, it is possible to prevent a situation in which recording and reproduction are performed while the optical disk 2 is kept incompletely engaged on the turntable 23a.

When the slider 122 is further slid in the f₁ direction, since the engaging projection 64 is moved from the second guide section 66b to the third guide section 66c of the loading cam plate 53, the loading arm 51 is rotationally moved in the arrow a₂ direction in FIG. 16. The contact section 61 is separated from the side of the optical disk 2.

When the slider 122 moves in the f₁ direction and the sub-slider 151 is further slid in the h₁ direction, the base unit 22 is lowered from the chucking position to the recording and reproduction position and stands by for operation for recording and reproduction by the user. As shown in FIG. 16, the tip of the sub-slider 151 is bumped against the bent piece 81 of the rotation supporting member 71. Consequently, the rotation supporting member 71 is further rotated in the arrow b₁ direction in the figure while stretching the urging coil spring 93. Thus, the contact member 74 of the eject arm 52 and the optical disk 2 centered are separated from each other. The first link arm 54 is moved together with the rotation supporting member 71 and is urged in the p₁ direction by the urging coil spring 93. Thus, in the second link arm 55 engaged with the first link arm 54, the guide projection 113 surmounts the protrusion 112c, which prevents reverse movement to the loading guide wall 112a side, and moves to the eject guide wall 112b.

As shown in FIG. 16, the slider 122 presses the stop lever 140, which realizes centering of the optical disk 2, to separate the stop lever 140 from the side of the optical disk 2. Consequently, the optical disk 2 is separated from the loading arm 51, the eject arm 52, the stop lever 140, and the centering guide piece 99 of the guide wall 96, which realize centering of the optical disk 2, and held on the turntable 23a in a free state. The optical disk 2 is allowed to be driven to rotate by the disk-rotation driving mechanism 24.

In this case, depression states of the first to the fourth switches SW1 to SW4 are detected as L, L, L, and H in order. Thus, it is seen that the base unit 22 is lowered to the recording and reproduction position and it is possible to drive to rotate the optical disk 2.

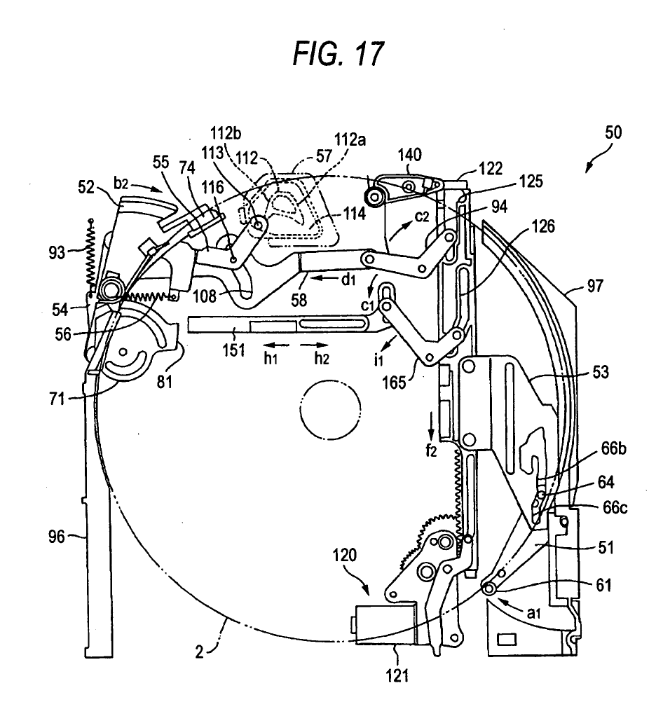

When the recording or reproduction operation is completed and operation for ejecting the optical disk 2 is performed by the user, first, the driving motor 121 of the driving mechanism 120 is reversely rotated and the slider 122 is slid in the arrow f₂ direction in FIG. 17. Consequently, since the engaging projection 64 moves from the third guide section 66c to the second guide section 66b of the loading cam plate 53, the loading arm 51 is rotationally moved in the arrow a₁ direction in FIG. 17 and the contact section 61 is brought into contact with the side of the optical disk 2.

The sub-slider 151 is slid in the arrow h₂ direction in the figure and the pressing on the rotation supporting member 71 is released. Thus, the eject arm 52 is rotationally moved in the arrow b₂ direction in the figure by the urging force of the urging coil spring 93 and the contact member 74 is brought into contact with the side of the optical disk 2. Since the first link arm 54 engaged with the rotation supporting member 71 is moved in the d₁ direction by the operation arm 58 and the urging coil spring 93 is contracted, the eject arm 52 is only rotationally moved to be brought into contact with the optical disk 2. An ejection force for the optical disk 2 is not generated.

Subsequently, when the slider 122 is further slid in the f₂ direction, the sub-slider 151 is slid in the arrow h₂ direction in FIG. 18 to lower the base unit 22. Consequently, the optical disk 2 is raised by the push-up pin 10 vertically provided from the bottom case 4 and the chucking with the turntable 23a is released.

In this case, depression states of the first to the fourth switches SW1 to SW4 are detected as L, H, L, and H in order. Thus, it is seen that the base unit 22 is lowered to the chucking release position and it is possible to safely eject the optical disk 2.

Thereafter, when the first guide groove 125 of the slider 122 is slid, the third link arm 94 engaged with the slider 122 is rotationally moved in the arrow c₂ direction in FIG. 18. Then, the operation arm 58 is moved in the arrow d₂ direction in the figure. As shown in FIGS. 18 and 19, according to the movement in the d₂ direction of the operation arm 58, the first link arm 54 is moved in the same direction. Then, the eject arm 52 is rotationally moved in the arrow b₂ direction in FIG. 18 according to an amount of movement of the operation arm 58 to eject the optical disk 2.

In this case, in the disk conveying mechanism 50, the loading arm 51 urged in the arrow a₁ direction in FIG. 18, in which the optical disk 2 is urged in the inserting direction, by the coil spring 62 is set in contact with the optical disk 2. However, since the engaging projection 64 is engaged with the first cam groove 66 of the loading cam plate 53, the loading arm 51 is allowed to rotationally move according to slide of the loading cam plate 53. Thus, free rotational movement of the loading arm 51 is regulated. When the loading cam plate 53 is slid in the arrow f₂ direction in FIG. 19 together with the slider 122, the loading arm 51 is rotationally moved in the arrow a₂ direction in the figure against the urging force of the coil spring 62 according to the slide of the loading cam plate 53. Thus, the loading arm 51 does not apply an urging force that hinders the ejection of the optical disk 2. Since the optical disk 2 is ejected while being held between the loading arm 51 and the eject arm 52, it is possible to prevent the optical disk 2 from suddenly springing out.

When the first link arm 54 is moved in the d₂ direction by the operation arm 58, the guide projection 113 of the second link arm 55 slides on the eject guide wall 112b of the loop cam 57. In this case, since both the first link arm 54 and the second link arm 55 are moved in the same direction by the operation arm 58, the helical tension coil 56 is not stretched. In other words, when the optical disk 2 is inserted, a moving direction of the first link arm 54 moved when the eject arm 52 is rotationally moved in the b₁ direction and a moving direction of the second link arm 55 moved when the guide projection 113 is guided by the loading guide wall 112a of the loop cam 57 are opposite. Since the first link arm 54 and the second link arm 55 separate from each other, the helical tension spring 56 is stretched to apply an urging force in the ejecting direction to the eject arm 52. However, when the optical disk 2 is ejected, since the guide projection 113 of the second link arm 55 is guided in the same direction as the moving direction of the first link arm 54 by the eject guide wall 112b, the first link arm 54 and the second link arm 55 are moved without being separating from each other. Therefore, the helical tension spring 56 is not stretched and the eject arm 52 is rotationally moved in the ejecting direction by the driving force of the driving mechanism 120 without being urged in the ejecting direction.

In this case, in the disk conveying mechanism 50, when the optical disk 2 is brought into sliding contact with the panel curtains provided in the disk slot 19 of the front panel 18, an urging force in the b₁ direction relatively acts on the eject arm 52 and the first link arm 54. Then, as described above, the rotational movement in the d₂ direction of the first link arm 54 is regulated because the engaging projection 116 of the second link arm is brought into contact with the sidewall of the cam groove 108 of the operation arm 58. Thus, the first link arm 54 and the eject arm 52 are rotationally moved following the operation arm 58 moved in the d₂ direction by an amount corresponding to an amount of slide in the f₂ direction of the slider 122. Therefore, the disk conveying mechanism 50 can rotationally move the eject arm 52 by an amount corresponding to a slide action of the slider 122 against the urging force in the b₁ direction and stably eject the optical disk 2 to the predetermined ejection position.

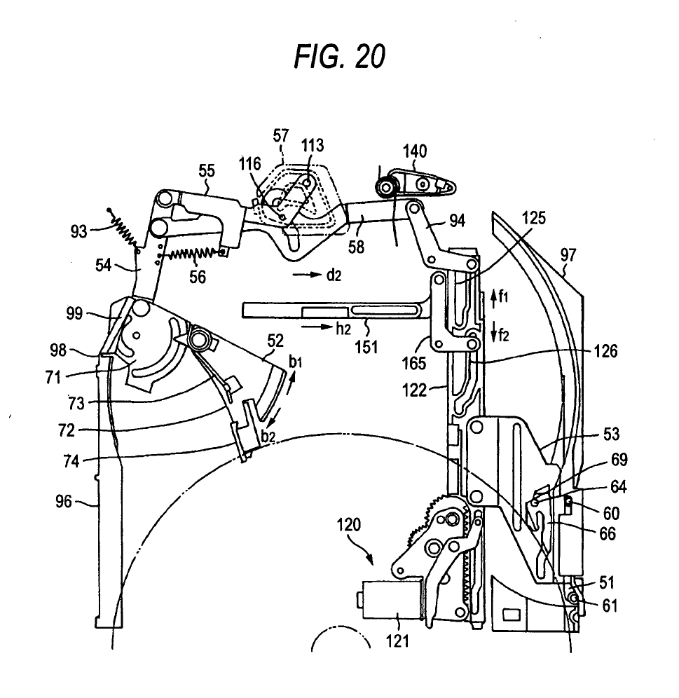

As shown in FIG. 20, when the slider 122 is moved to an initial position, since the detection switch is depressed, the slide action is stopped. According to the stop of the slide operation, the eject arm 52 is also rotationally moved to the initial position by the operation arm 58 and the first link arm 54 to stop the optical disk 2 in a position where the center hole 2a is ejected from the disk slot 19. In the loading arm 51, the engaging projection 64 is engaged with the projection 69 formed in the first cam groove 66 of the loading cam plate 53 and the contact section 61 is retracted from the conveyance area of the optical disk 2.

In this case, depression states of the first to the fourth switches SW1 to SW4 are detected as H, H, H, and H in order. Thus, it is seen that the optical disk 2 is conveyed to the predetermined ejection position by the eject arm 52. Thus, the driving of the driving motor 121 is stopped.

In a state in which the optical disk 2 is inserted by a predetermined amount and the driving of the driving motor 121 is started, when the user quickly grips the optical disk 2, for example, noticing that the user has inserted the optical disk 2 by mistake, the disk conveying mechanism 50 stops the driving motor 121 and, then, reversely drives the driving motor 121 to eject the optical disk 2.

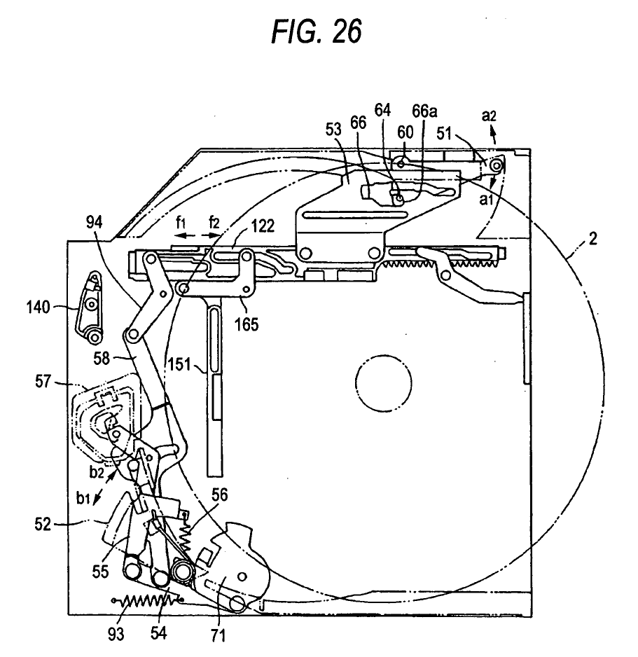

Specifically, as shown in FIG. 26, when the optical disk 2 is inserted by the predetermined amount from the disk slot 19 and the driving motor 121 is driven, the loading arm 51 is rotationally moved in the arrow a₁ direction in the figure according to the movement in the f₁ direction of the slider 122 and the loading cam plate 53. Here, when the optical disk 2 is gripped by the user, the rotational movement of the loading arm 51 is regulated. On the other hand, the loading cam plate 53 is slid in the f₁ direction together with the slider 122. Thus, the engaging projection 64 protrudingly provided in the loading arm 51 is locked to the tip of the first guide section 66a of the loading cam plate 53. Consequently, the slide in the f₁ direction of the slider 122 is regulated and the driving of the driving motor 121 is stopped. When a predetermined time elapses in this state, the driving motor 121 is reversely driven and the optical disk 2 is ejected in a process opposite to the insertion process for the optical disk 2.

In this case, since the eject arm 52 is also rotationally moved by the predetermined amount according to the predetermined amount of insertion of the optical disk 2, the first and the second link arms 54 and 55 are moved in directions in which the link arms separate from each other. The helical tension spring 56 suspended between the first and the second link arms 54 and 55 are stretched. Therefore, when the driving motor 121 is reversely driven and the slide of the slider 122 in the f₂ direction is completed, the first link arm 54 subjected to the urging force of the helical tension spring 56 is rotationally moved. The eject arm 52 is rotationally moved in the arrow b₂ direction in FIG. 26. Therefore, in the disk drive device 1, the eject arm 52 is urged to rotationally move in the arrow b₁ direction in FIG. 26, in which the optical disk 2 is ejected to the outside of the disk slot 19, by the helical tension spring 56. The eject arm 52 ejects the optical disk 2 with the urging force of the helical tension spring 56. Therefore, it is possible to prevent a situation in which, when the optical disk 2 is gripped at the time of loading of the optical disk 2, the driving of the driving motor 121 is stopped and the optical disk 2 is left as being incompletely exposed from the disk slot 19.

It is possible to detect such abnormal conveyance of the optical disk 2 by monitoring depression states of the first to the fourth switches SW1 to SW4 mounted on the circuit board 59 using the microcomputer. As shown in FIG. 24, when time of movement of the slider 122 from a state in which the first switch SW1 is depressed by the eject arm 52 until it is detected that the base unit 22 is lowered to the chucking release position (LHHH to LHLH) is equal to or longer than a predetermined time, for example, three seconds or when time until the base unit 22 is moved from the chucking release position to the recording and reproduction position through the chucking position (LHLH to LLLH) is equal to or longer than the predetermined time, the abnormal conveyance is detected. The driving motor 121 is stopped or reversely rotated to eject the optical disk 2.

When an obstacle such as a book is placed in front of the disk slot 19 at the time of ejection of the optical disk 2, it is difficult to eject the optical disk 2 because the optical disk 2 comes into contact with the obstacle. Thus, excessive loads are applied to the driving motor 121 of the driving mechanism 120. Since the optical disk 2 is held between the eject arm 52 rotationally moved by the driving force of the driving motor 121 and the obstacle, excessive loads are also applied to the optical disk 2.

In the disk drive device 1, the rotation supporting member 71 of the eject arm 52 and the push-out arm 72 are engaged with each other to freely move rotationally in the b₁ direction with the engaging section 77 as a fulcrum and urged in the b₂ direction with a predetermined force by the coil spring 73. Therefore, even when an obstacle that hinders the ejection of the optical disk 2 is placed and a force in a direction opposite to the ejecting direction of the optical disk 2 is applied to the eject arm 52 at the time of ejection of the optical disk 2, it is possible to prevent a situation in which, when the push-out arm 72 subjected to the force in the opposite direction is rotationally moved in the b₁ direction, excessive loads are applied to the driving motor 121 and the optical disk 2.

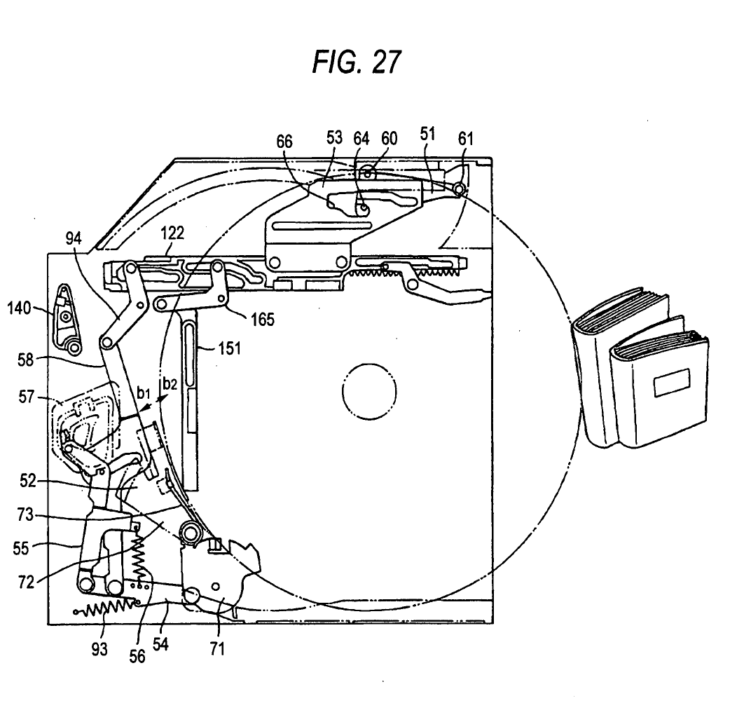

When the push-out arm 72 of the eject arm 52 is rotationally moved in the b₁ direction, the disk drive device 1 stops the driving of the driving motor 121. When a predetermined time elapses in a state in which an obstacle is placed in front of the disk slot 19 and the ejection of the optical disk 2 is hindered, the disk drive device 1 draws the optical disk 2 into the loading position again. In other words, as shown in FIG. 27, when the optical disk 2 is ejected to the outside from the disk slot 19, one side of the optical disk 2 comes into contact with the obstacle, and the ejection of the optical disk 2 is stopped for the predetermined time, the driving motor 121 is rotated reversely. Therefore, the first and the second link arms 54 and 55 and the operation arm 58 are moved reversely to the movement to that point to perform the loading operation for the optical disk 2. In this case, since the first and the second link arms 54 and 55 are also moved without separating from each other, the helical tension spring 56 is not stretched and the urging force in the ejecting direction does not act on the eject arm 52.

Consequently, the disk drive device 1 can prevent a situation in which the optical disk 2 is left as being held between the eject lever 52 rotationally moved in the ejecting direction and the obstacle and prevent excessive loads from being applied to the driving motor 121 and the optical disk 2.

It is possible to detect such abnormal conveyance of the optical disk 2 by monitoring depression states of the first to the fourth switches SW1 to SW4 mounted on the circuit board 59 using the microcomputer. As shown in FIG. 25, when time of movement of the slider 122 from the reversal of the driving motor 121 until the base unit 22 is lowered from the recording and reproduction position to the chucking release position through the chucking position (LLLH to LHLH) is equal to or longer than a predetermined time, for example, three seconds or when time of movement of the slider 122 from time when the base unit 22 is lowered to the chucking release position until a state in which none of the first to the fourth switches SW1 to SW4 is depressed (LHLH to HHHH) is equal to or longer than the predetermined time, the abnormal conveyance is detected. The driving motor 121 is stopped or normally rotated to load the optical disk 2.

As described above, in the disk conveying mechanism 50 of the disk drive device 1 according to the embodiment, when the optical disk 2 is inserted, in the process in which the optical disk 2 is inserted to the predetermined position by the user, the first link arm 54 and the second link arm 55 are guided in the direction in which the link arms separate from each other by the loop cam 57. This makes it possible to cause the urging force in the ejecting direction by the helical tension spring 56 suspended between the link arms to act on the eject arm 52. Thus, it is possible to prevent a situation in which, when the insertion of the optical disk 2 by the user is stopped, the optical disk 2 is left as being incompletely inserted into the housing 3.

When the optical disk is ejected, the first link arm 54 and the second link arm 55 are moved while being brought close to each other by the loop cam 57 to eliminate the urging force in the ejecting direction by the helical tension spring 56 given to the eject arm 52. The eject arm 52 is rotationally moved according to the operation of the slider 122 and the operation arm 58 subjected to the driving force of the driving mechanism 120. Therefore, the disk conveying mechanism 50 can stably eject by the driving force of the driving mechanism 120, without relying on an elastic force, the optical disk 2 to the predetermined stop position where the center hole 2a of the optical disk 2 is ejected to the outside of the housing 3.

Moreover, the disk conveying mechanism 50 does not adopt a mechanism for rotationally moving the eject lever 52 with the urging force of the helical tension spring 56 at the time of ejection of the optical disk 2. Thus, contact sound generated when, for example, an eject lever subjected to such an urging force comes into contact with an optical disk is not generated. Therefore, the disk drive device 1 can also improve feeling of use because there is no noise at the time of ejection of the optical disk 2.

In the disk drive device 1 according to the embodiment, the stopper 100 that prevents misinsertion of the small-diameter optical disk 101 may be provided in the contact member 74 of the eject arm 52. The disk drive device 1 is formed exclusively for the optical disk 2 having a large diameter (e.g., 12 cm). However, it is likely that the user inserts the optical disk 101 having a small diameter (e.g., 8 cm) in the disk drive device 1 by mistake. In this case, when the small-diameter disk 101 is brought into contact with the contact member 74 and the eject arm 52 is pushed in the b₁ direction, the eject arm 52 is not rotationally moved to a position where the driving mechanism 120 is driven. Thus, it is possible to eject the small-diameter disk 101 with an urging force in the b₂ direction. On the other hand, when the small-diameter disk 101 is inserted while being shifted to the loading arm 51 side where the small-diameter disk 101 is not brought into contact with the contact member 74 of the eject arm 52, the small-diameter disk 101 is inserted deep into the housing 3. Thus, it is likely the small-diameter disk 101 remains in a position deviating from the rotational movement area of the eject arm 52.

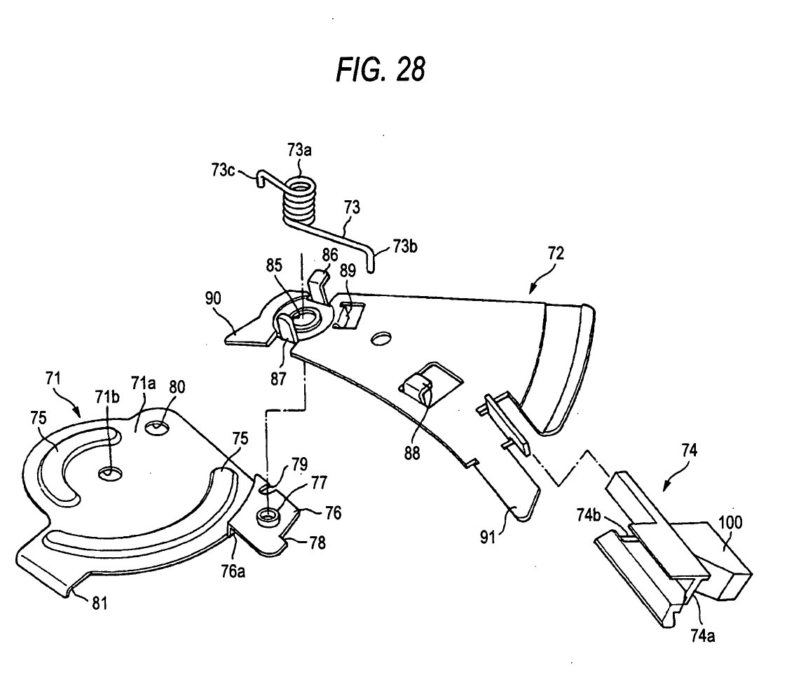

Thus, as shown in FIG. 28, in the eject arm 52, the stopper 100 for preventing misinsertion of the small-diameter disk 101 is formed in the contact member 74 in order to prevent, even when the small-diameter disk 101 is inserted while being shifted to the loading arm 51 side, the small-diameter disk 101 from being inserted deep into the housing 3.

The stopper 100 is formed to be projected further to the loading arm 51 side than the contact member 74. Even when the small-diameter disk 101 is inserted while being shifted to the loading arm 51 side, a part of the stopper 100 comes into contact with the small-diameter disk 101 to make it possible to prohibit further insertion of the disk.

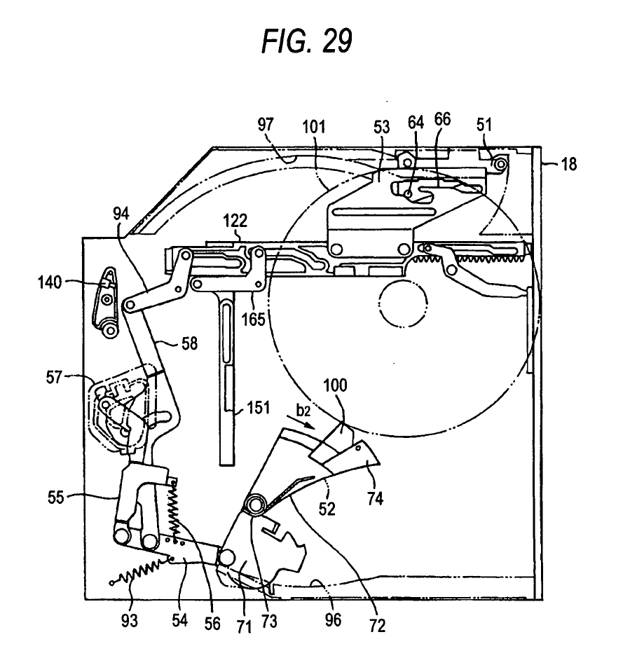

In a state of standby for insertion of the optical disk 2 in which the eject arm 52 is rotationally moved in the arrow b₂ direction in FIG. 29, a clearance between the stopper 100 and the end on the loading arm 51 side of the disk slot 19 is formed smaller than the diameter of the small-diameter disk 101. Therefore, even when the small-diameter disk 101 is inserted while being shifted to the loading arm 51 side, the stopper 100 can surely prevent misinsertion of the small-diameter disk 101.

When the eject arm 52 is in the state of standby for insertion of the optical disk 2, the stopper 100 is rotationally moved to a position where the stopper 100 comes into contact with the insertion end face of the small-diameter disk 101 when substantially the entire small-diameter disk 101 is inserted from the disk slot 19. In other words, the stopper 100 is brought into contact with the small-diameter disk 101 when substantially the entire small-diameter disk 101 is inserted. Therefore, since the small-diameter disk 101 comes into contact with the stopper 100 in a state in which a portion that can be pushed into the inside of the device from the outside of the disk slot 19 is hardly left, further insertion of the small-diameter disk 101 is regulated. Thus, it is difficult for the user to further insert the small-diameter disk 101 into the housing 3.

The stopper 100 is rotationally moved in the b₁ direction and the b₂ direction in the disk conveyance area together with the eject arm 52. In this case, if the eject arm 52 is formed in length not allowing the stopper 100 to rotationally move on the disk mounting section 23 of the base unit 22 exposed on the disk conveyance are, it is possible to prevent a situation in which the stopper 100 swings during the rotational movement of the eject arm 52 and collides with the turntable 23a of the disk mounting section 23 and the engaging projection 33a.

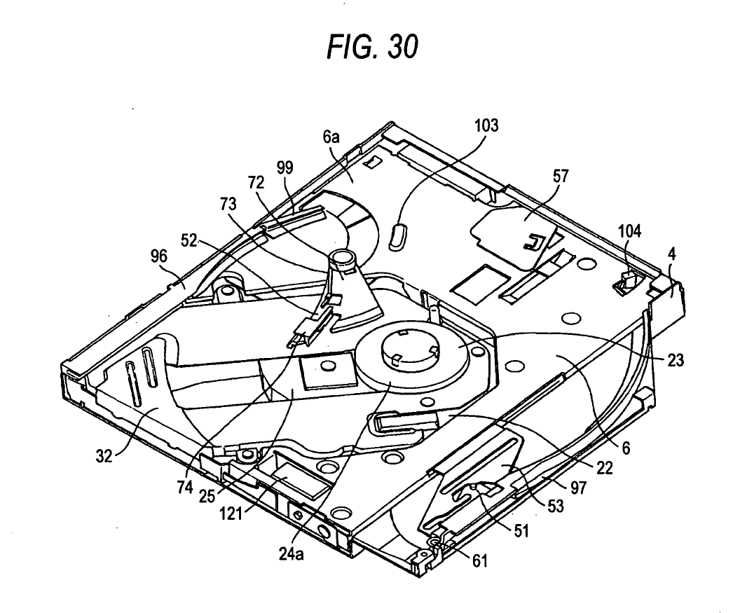

In the disk drive device 1 according to the embodiment, as shown in FIG. 30, a projection 103 for rotationally moving the eject arm 52 to prevent collision with the disk mounting section 23 may be provided on the upper surface 6a of the main chassis 6. The projection 103 is formed in a position, onto which the push-out arm 74 is moved when the contact member 74 of the eject arm 52 passes over the disk mounting section 23 or near the disk mounting section 23, on an area where the push-out arm 72 of the eject arm 52 rotationally moves on the upper surface 6a of the main chassis 6.

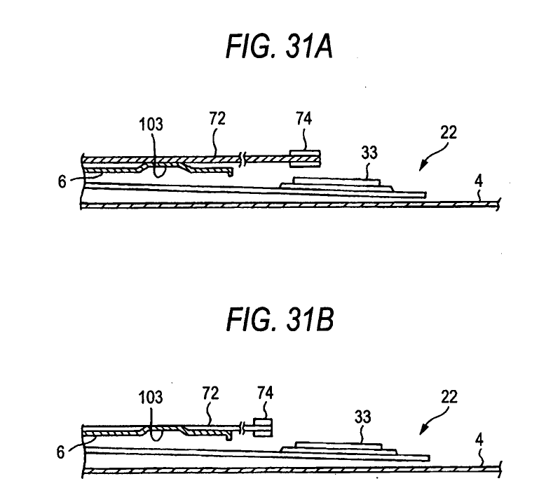

Therefore, when the optical disk 2 is inserted and the eject arm 52 is rotationally moved in the b₁ direction, the push-out arm 72 moves onto the projection 103 to lift the contact member 74. Therefore, as shown in FIG. 31A, rotational movement loci of the contact member 74 and the optical disk 2 supported by the contact member 74 also rise. This makes it possible to prevent collision of eject arm 52 with the turntable 23a of the disk mounting section 23 and the engaging projection 33a.

The projection 103 is formed only in the position onto which the push-out arm 74 is moved when the contact member 74 of the eject arm 52 passes over the disk mounting section 23 or near the disk mounting section 23. Therefore, a rotational movement locus of the eject arm 52 does not rise in portions other than a portion where the projection 103 is formed. Therefore, compared with the case in which a projection is provided on the eject arm 52 side, it is unnecessary to secure height of rotational movement of the eject arm 52 over the entire rotational movement area. In other words, when a projection projecting downward is formed in the eject arm 52, on the upper surface 6a of the main chassis 6, the projection is typically moved onto the upper surface 6a. Thus, a locus of the eject arm 52 is high throughout the rotational movement. In areas other than the main chassis 6, it is necessary to set a locus of the eject arm 52 high in order to prevent collision of the projection projecting downward and the other members. Therefore, thickness of the housing 3 increases to make it difficult to reduce a size and thickness of the disk drive device 1. Moreover, when the eject arm 52 swings because of disturbance or the like during the rotational movement, it is also likely that the projection comes into sliding contact with or collides with the other members located below the rotational movement area of the eject arm 52, for example, the optical pickup 25.

In this regard, in the disk drive device 1 according to the embodiment, since the projection 103 is formed on the upper surface 6a of the main chassis 6, a locus of the eject arm 52 is high only in a part that moves onto the projection 103 and is low in other areas. As shown in FIG. 31B, since the eject arm 52 does not have the projection projecting downward, it is unlikely that, for example, the eject arm 52 collides with the other members located below the rotational movement area of the eject arm 52. Therefore, it is possible to reduce a size and thickness of the housing 3.

The driving mechanism 120 that supplies a driving force to the disk conveying mechanism 50 includes the driving motor 121, the slider 122 that is subjected to the driving force of the driving motor 121 and slides in the bottom case 4, and a gear string 123 that transmits the driving force of the driving motor 121 to the slider 122. These members are disposed in the bottom case 4. The driving mechanism 120 slides the slider 122 with the driving motor 121 to drive the disk conveying mechanism 50 and the base elevating mechanism 150.

When the optical disk 2 is inserted to the predetermined position, the first switch SW1 is depressed by the rotation supporting member 71 of the eject arm 52. The driving motor 121 is driven in a normal rotation direction for moving the slider 122 in the f₁ direction. When eject operation is performed, the driving motor 121 is driven in a reverse rotation direction for moving the slider 122 in the f₂ direction. The slider 122 is moved in the arrow f₁ direction or the arrow f₂ direction in FIG. 12 according to loading and ejection of the optical disk 2 to drive the respective arms of the disk conveying mechanism 50 and the base elevating mechanism 150. The gear string 123 transmits the driving force of the driving motor 121 to the slider 122 via a rack section 131.

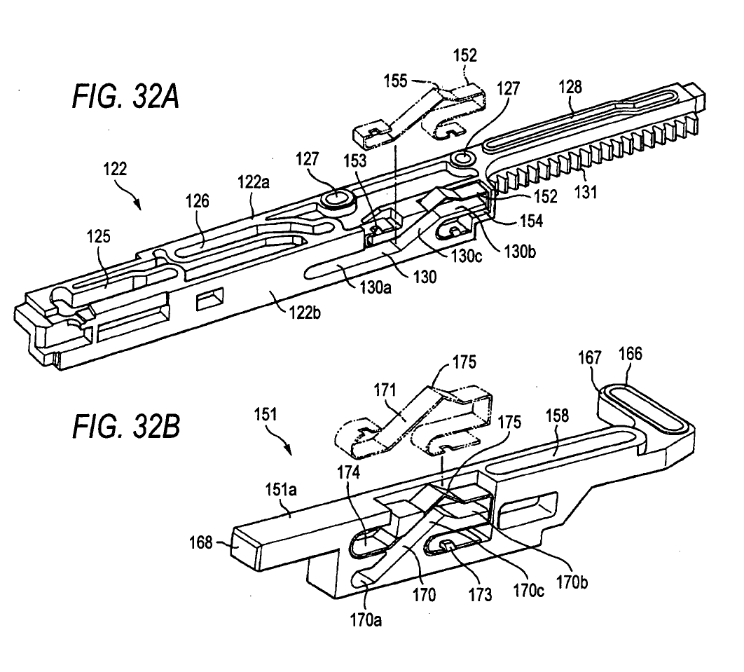

As shown in FIG. 32A, the slider 122 is made of a resin member formed in a substantially rectangular parallelepiped shape as a whole. The upper surface 122a of the slider 122 has formed therein the first guide groove 125 with which the engaging projection 109 formed in the third link arm 94 engages, a second guide groove 126 with which the coupling arm 165 that drives the sub-slider 151 of the base elevating mechanism 150 is engaged, the pair of engaging recesses 127, 127 that engage with the pair of engaging protrusions 68, 68 formed in the loading cam plate 53, and a third guide groove 128 with which one end of an opening and closing arm 191 of a disk-insertion regulating mechanism 190 described later is engaged.

On the side 122b on the base unit 22 side of the slider 122, the first cam slit 130 through which the first supporting shaft 47 protrudingly provided on the sub-chassis 29 of the base unit 22 is inserted and the rack section 131 that engages with the gear string 123 are formed. A first guide plate 152 that prevents backlash of the first supporting shaft 47 of the sub-chassis 29 and causes the disk-rotation driving mechanism 24 to stably operate is assembled with the first cam slit 130. In the lower surface 122c of the slider 122, a slide guide groove 129, a slide direction of which is guided by the pair of guide protrusions 124, 124 protrudingly provided from the bottom case 4, are formed along the longitudinal direction (see FIG. 10).

Such a slider 122 is arranged between one side of the bottom case 4 and the base unit 22 on the bottom surface of the bottom case 4. The slider 122 is located below the optical disk 2 inserted into the housing 3 from the disk slot 19. The upper surface of the slider 122 has height slightly smaller than that of the deck section 4a. The slider 122 is covered with the main chassis 6 and driven to slide in the front to rear direction via the driving motor 121 and the gear string 123 provided on the bottom surface of the bottom case 4.

The driving mechanism 120 moves, in association with the slide action of the slider 122, the third link arm 94 and the operation arm 58 engaged with the third link arm 94 to regulate the rotational movement of the eject arm 52. The driving mechanism 120 also moves the loading cam plate 53 back and forth to rotationally move the loading arm 51. Consequently, the driving mechanism 120 performs, according to the slide of the slider 122, a loading operation for drawing the optical disk 2 into the housing 3 from the disk slot 19 and an eject operation for ejecting the optical disk 2 to the outside of the disk slot 19 from the disk mounting section 23.

The stop lever 140 that performs a centering operation for positioning the loaded optical disk 2 on the disk mounting section 23 will be explained. The stop lever 140 has formed therein, as shown in FIG. 6, a lever body 141 supported by the main chassis 6 to freely move rotationally, a stop protrusion 142 that is protrudingly provided from one end of the lever body 141 and stops the optical disk 2 in the centering position, a supporting protrusion 143 through which an annular portion of a coil spring 144 is inserted on the other end side of the lever body 141 and that causes the main chassis 6 to support the lever body 141 to freely move rotationally, and a regulating projection 145 that is inserted through a guide hole 146 drilled in the main chassis 6 and regulates the rotational movement of the lever body 141 to stop the stop protrusion 142 in the centering position of the optical disk 2.

The lever body 141 is made of a resin member. One end 141a at which the stop protrusion 142 is protrudingly provided is formed in a substantially arcuate shape. Since the supporting protrusion 143 is supported by the main chassis 6, the one end 141a is disposed to project to the slide area of the slider 122. Consequently, the tip of the slider 122 and the lever body 141 come into contact with each other according to the slide action of the slider 122 and the stop lever 140 is allowed to rotationally move around the supporting protrusion 143.

Since the stop protrusion 142 is protrudingly provided from one end of the lever body 141, the stop protrusion 142 is projected onto the upper surface 6a of the main chassis 6 from a rotational movement hole 147 formed in the main chassis 6 and allowed to come into contact with the outer circumference of the optical disk 2. When the side of the insertion end side of the optical disk 2 drawn in by the loading arm 51 is brought into contact with the stop protrusion 142, the stop protrusion 142 performs the centering operation for stopping the optical disk 2 on the disk mounting section 23. The rotational movement hole 147 that projects the stop protrusion 142 onto the main chassis 6 is formed in a substantially arcuate shape. Thus, the stop protrusion 142 is allowed to retract from the stop position where the optical disk 2 is centered.

The supporting protrusion 143 is a member of a substantially cylindrical shape including a hollow section in which a screw groove is cut. The supporting protrusion 143 is protrudingly provided at the other end of the lever body 141. Since the hollow section is screwed continuously from the screw hole drilled in the main chassis 6, the supporting protrusion 143 is supported by the main chassis 6 to freely rotate in an arrow g₁ direction and an arrow g₂ direction in FIG. 12. The outer circumference of the supporting protrusion 143 is inserted through the annular portion of the coil spring 144. One end of the coil spring 144 is engaged with the lever body 141 and the other end is engaged with the circuit board 59 disposed in the bottom case 4. Consequently, the coil spring 144 urges the stop lever 140 to rotationally move in the arrow g₁ direction in FIG. 12 around the supporting protrusion 143.

The regulating projection 145 regulates a rotational movement area of the lever body 141 urged to rotationally move by the coil spring 144. As shown in FIG. 3, the regulating projection 145 is protrudingly provided upward from the lever body 141 and exposed on the upper surface 6a of the main chassis 6 from the guide hole 146 formed in the main chassis 6. The guide hole 146 regulates a rotational movement area of the regulating projection 145. Thus, the guide hole 146 stops the lever body 141, which is urged to rotationally move in the g₁ direction by the coil spring 144, in the predetermined position where centering of the optical disk 2 is performed. Since the guide hole 146 is formed in an arcuate shape, the guide hole 146 allows the lever body 141 to retract from the stop position where centering of the optical disk 2 is performed.

The lever body 141 is urged by the coil spring 144 and the regulating projection 145 is engaged with one end on the arrow g₁ side of the guide hole 146. Thus, the stop lever 140 is rotationally moved to the stop position where the stop protrusion 142 stops the optical disk 2 in the centering position. When the optical disk 2 is loaded, the side of the stop lever 140 on the insertion end side of the optical disk 2 is brought into contact with the stop protrusion 142. Consequently, the stop lever 140 positions the optical disk 2 on the disk mounting section 23. After the centering is completed, the one end 141a of the lever body 141 is pressed against the tip of the slider 122 conveyed in the f₁ direction and the stop lever 140 is rotationally moved in the arrow g₂ direction. Consequently, the stop protrusion 142 is separated from the outer circumference of the optical disk 2 to allow the optical disk 2 to rotate. When the optical disk 2 is ejected, since the slider 122 is slid in the f₂ direction, the stop lever 140 is urged by the coil spring 144 and rotationally moved to the stop position where the stop protrusion 142 stops the optical disk 2 in the centering position. The stop lever 140 prepares for loading of the optical disk 2.

The base elevating mechanism 150 that operates the base unit 22 to rise and fall in association with the slide action of the slider 122 will be explained. The base elevating mechanism 150 operates the base unit 22 to rise and fall among a chucking position where the base unit 22 is lifted to mount the optical disk 2, which is positioned in the disk mounting position, on the turntable 23a of the disk mounting section 23, a chucking release position where the base unit 22 is lowered to eject the optical disk 2 from the turntable 23a of the disk mounting section 23, and a recording and reproduction position where the base unit 22 is located between the chucking position and the chucking release position to record a signal in or reproduce a signal from the optical disk 2.

Specifically, the base elevating mechanism 150 lifts and lowers the first supporting shaft 47 and the second supporting shaft 48 formed in the base unit 22 using the slider 122 and the sub-slider 151, which is slid according to the slide action of the slider 122, to lift and lower the base unit 22. As shown in FIG. 32A, in the side opposed to the base unit 22 of the slider 122, the first cam slit 130 that operates to lift and lower the base unit 22 to the chucking release position and the recording and reproduction position is formed over the longitudinal direction. The first cam slit 130 has formed therein a lower-side horizontal surface section 130a corresponding to the chucking release position, an upper-side horizontal surface section 130b corresponding to the recording and reproduction position, and an inclined surface section 130c that connects the lower-side horizontal surface section 130a and the upper-side horizontal surface section 130b. The first supporting shaft 47 protrudingly provided on the sub-chassis 29 of the base unit 22 is slidably inserted through the first cam slit 130.

In the first cam slit 130, as shown in FIG. 32A, the first guide plate 152 that guides the movement of the first supporting shaft 47 and prevents backlash of the first supporting shaft 47 in the recording and reproducing position to cause the disk-rotation driving mechanism 24 to stably operate is disposed. The first guide plate 152 is made of a leaf spring member. One end of the first guide plate 152 is locked to a locking piece 153 formed above the first cam slit 130 and the other end is locked to a locking recess 154 formed below the first cam slit 130. The first guide plate 152 has formed therein in a bent state, above a contact of the upper-side horizontal surface section 130b and the inclined surface section 130c, a projecting section 155 to which the first supporting shaft 47 moves when the base unit 22 is lifted to the chucking position and that projects to the upper surface 122a side of the slider 122 when the first supporting shaft 47 is moved to the upper-side horizontal surface section 130b.

The lower-side horizontal surface section 130a of the first cam slit 130 has height slightly larger than the diameter of the first supporting shaft 47 and is formed to freely slide. On the other hand, height between the upper-side horizontal surface section 130b and the first guide plate 152 is set identical with or slightly smaller than the diameter of the first supporting shaft 47. Therefore, when the first supporting shaft 47 is moved to the upper-side horizontal surface section 130b, the first supporting shaft 47 is pressed in and held between the first guide plate 152 and the upper-side horizontal surface section 130b. Therefore, the first guide plate 152 can control vibration caused by the spindle motor 24a of the disk-rotation driving mechanism 24 provided in the base unit 22 and stably rotate the optical disk 2.

Since the first supporting shaft 47 is held between the first guide plate 152 and the upper-side horizontal surface section 130b, the projecting section 155 projects on the upper surface 122a of the slider 122 and pressed against the upper surface 6a of the main chassis 6. Therefore, the slider 122 is pressed to the bottom case 4 side by the first guide plate 152. Thus, it is possible to control influences of vibration due to the driving of the base unit 22 and disturbance.

The sub-slider 151 supports the second supporting shaft 48 protrudingly provided from the sub-chassis 29 of the base unit 22 and is engaged with the slider 122. The sub-slider 155 is disposed to be capable of sliding in the arrow h₁ direction or the arrow h₂ direction in FIG. 12 orthogonal to the loading direction of the optical disk 2 according to the slide action of the slider 122.

As shown in FIG. 32B, the sub-slider 151 is made of a long flat member of synthetic resin. An upper guide groove 158, with which a guide projection 157 projected from the main chassis 6 is engaged, is formed over the longitudinal direction on the upper surface 151a of the sub-slider 151. In the sub-slider 151, a lower guide groove 160, with which a guide projection 159 projected from the bottom case 4 is engaged, is formed over the longitudinal direction in a position deviating from the upper guide groove 158 in the lower surface 151b (see FIG. 10). When the guide projection 157 projected from the main chassis 6 is engaged with the upper guide groove 158, the guide projection 157 slides in the upper guide groove 158. When the guide projection 159 projected from the bottom chassis 4 is engaged with the lower guide groove 160, the guide projection 159 slides in the lower guide groove 158. Thus, the sub-slider 151 is slid in the arrow h₁ direction or the arrow h₂ direction in association with the slide action of the slider 122.

In the sub-slider 151, an engaging groove 166, with which the coupling arm 165 coupled to the slider 122 is engaged, is formed at one end in the longitudinal direction located on the slider 122 side. The engaging groove 166 is provided in an engaging piece 167 extended in a direction orthogonal to the longitudinal direction of the sub-slider 151. In the sub-slider 151, the other end on the opposite side of one end where the engaging piece 167 is formed is formed as a contact projection 168 that is brought into contact with the rotation supporting member 71 of the eject arm 52 at the time of loading of the optical disk 2. When the optical disk 2 is loaded, the contact projection 168 is brought into contact with the bent piece 81 of the rotation supporting member 71. Thus, the contact projection 168 moves the guide projection 113 of the second link arm 55 coupled to the first link arm 54 to surmount the protrusion 112c of the loop cam 57 via the first link arm 54 coupled to the rotation supporting member 71. Further, the contact projection 168 rotationally moves the eject arm 54 until the contact member 74 is released from the side of the optical disk 2.

In the sub-slider 151, on the side 151b on the disk slot 19 side, the second cam slit 170 that operates to lift and lower the base unit 22 to the chucking position, the chucking release position, and the recording and reproduction position is formed over the longitudinal direction together with the first cam slit 130. The second cam slit 170 has formed therein a lower-side horizontal surface section 170a corresponding to the chucking release position, an upper-side horizontal surface section 170b corresponding to the recording and reproduction position, and an inclined surface section 170c that connects the lower-side horizontal surface section 170a and the upper-side horizontal surface section 170b and corresponds to the chucking position. The second supporting shaft 48 protrudingly provided on the sub-chassis 29 of the base unit 22 is slidably inserted through the second cam slit 170b.

The inclined surface section 170c of the second cam slit 170 is provided up to a position higher than the position of the upper-side horizontal surface section 170b and slightly descends to guide the base unit 22 to the upper-side horizontal surface section 170b. Consequently, when the sub-slider 151 slides in the h₁ direction, the second supporting shaft 48 rises on the inclined surface section 170c from the lower-side horizontal surface section 170a. The base unit 22 guided by the second cam slit 170 is moved from the chucking release position to the chucking position. In this case, in the base unit 22, the turntable 23a and the contact projection 8 provided in the top plate section 5a of the top cover 5 hold the periphery of the center hole 2a of the optical disk 2 conveyed to the disk mounting section 23 to perform chucking of the optical disk 2. When the sub-slider 151 is further slid in the h₁ direction, the second supporting shaft 48 falls from the inclined surface section 170c to the upper-side horizontal surface section 170b. Thus, the base unit 22 is moved from the chucking position to the recording and reproduction position.

As shown in FIG. 32B, in the second cam slit 170, as in the first cam slit 130, a second guide plate 171 that guides the movement of the second supporting shaft 48 and prevents backlash of the second supporting shaft 48 in the recording and reproduction position to cause the disk-rotation driving mechanism 24 to stably operate is disposed. One end of the second guide plate 171 is locked to a locking piece 173 formed above the second cam slit 170. The other end is locked to a locking recess 174 formed below the second cam slit 170. The second guide plate 171 has formed therein in a bent state, above a contact of the upper-side horizontal surface section 170b and the inclined surface section 170c, a projecting section 175 to which the second supporting shaft 48 moves when the base unit 22 is lifted to the chucking position and that projects to the upper surface 151a side of the sub-slider 151 when the second supporting shaft 48 is moved to the upper-side horizontal surface section 170b.

The lower-side horizontal surface section 170a of the second cam slit 170 has height slightly larger than the diameter of the second supporting shaft 48 and is formed to freely slide. On the other hand, height between the upper-side horizontal surface section 170b and the second guide plate 171 is set identical with or slightly smaller than the diameter of the second supporting shaft 48. Therefore, when the second supporting shaft 48 is moved to the upper-side horizontal surface section 170b, the second supporting shaft 48 is pressed in and held between the second guide plate 171 and the upper-side horizontal surface section 170b. Therefore, the second guide plate 171 can control, in conjunction with the first guide plate 152, vibration caused by the spindle motor 24a of the disk-rotation driving mechanism 24 provided in the base unit 22 and stably rotate the optical disk 2.

Since the second supporting shaft 48 is held between the second guide plate 171 and the upper-side horizontal surface section 170b, the projecting section 175 projects on the upper surface 151a of the sub-slider 151 and is pressed against the upper surface 6a of the main chassis 6. Therefore, the sub-slider 151 is pressed to the bottom case 4 side by the second guide plate 171. Thus, it is possible to control influences of vibration due to the driving of the base unit 22 and disturbance.

Such a sub-slider 151 is engaged with the engaging groove 166. The coupling arm 165 that couples the slider 122 and the sub-slider 151 is formed in a substantially L shape. The coupling arm 165 has a bent section 165a attached to the main chassis 6 to freely move rotationally. The coupling arm 165 has an engaging projection 177 formed at one end 165b on the side of a short side extended from the bent section 165a. The engaging projection 177 is engaged with the second guide groove 126 of the slider 122 to freely move. Further, the coupling arm 165 has an engaging projection 178 formed at the other end 165c on the side of a long side. The engaging projection 178 is engaged with the engaging groove 166 of the sub-slider 151 to freely move.

When the slider 122 is moved in the f₁ direction, since the engaging projection 177 moves in the second guide groove 126 of the slider 122, the coupling arm 165 is rotationally moved in an i₁ direction with the bent section 165a as a fulcrum. The engaging projection 178 slides the sub-slider 151 in the h₁ direction while moving in the engaging groove 166. When the slider 122 is moved in the f₂ direction, since the engaging projection 177 moves in the second guide groove 126, the coupling arm 165 is rotationally moved in an i₂ direction with the bent section 165a as a fulcrum. The engaging projection 178 slides the sub-slider 151 in the h₂ direction while moving in the engaging groove 166.

The disk drive device 1 includes, as shown in FIGS. 3, 6, and 33, a guide pin 180 that guides the base unit 22 such that the center hole 2a of the optical disk 2 conveyed to the centering position by the disk conveying mechanism 50 and the turntable 23a of the disk mounting section 23 provided in the base chassis 27 are aligned when the base unit 22 is lifted to the chucking position.

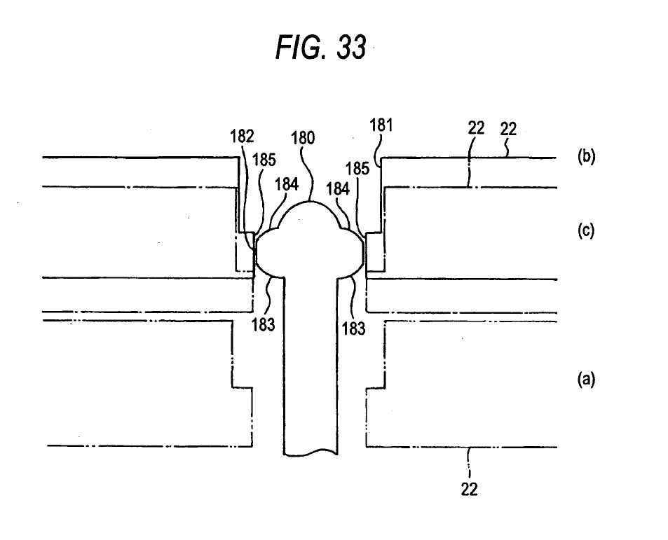

The guide pint 180 is vertically provided from the bottom surface of the bottom case 4. As shown in FIG. 33, a flange section 182 inserted through a guide hole 181 formed in the base chassis 27 is formed in an upper part of the guide pin 180. The flange section 182 has a diameter slightly larger than a diameter of the guide hole 181 of the base chassis 27. The flange section 182 has formed therein a first guise section 183 including an inclined surface expanded in diameter toward the upper end thereof and a second guide section 184 including an inclined surface reduced in diameter toward the upper end thereof. When the base chassis 27 is lifted or lowered, the flange section 182 is inserted through the guide hole 181 with the first and the second guide sections 183 and 184 being in slide contact with guide walls 185 formed in the guide hole 181. Consequently, the flange section 182 guides the base unit 22 to the chucking position or the chucking release position.

The guide hole 181 of the base chassis 27, through which the guide pin 180 inserted, is drilled near the turntable 23a spaced apart from the third supporting shaft 49 serving as a rotational fulcrum of the base unit 22. In the guide hole 181, as shown in FIG. 33, the guide walls 185 are formed to swell in a lower part of the base chassis 27. The guide walls 185 form a clearance slightly larger than the diameter of the flange section 182 of the guide pin 180. When the flange section 182 is inserted through this clearance, the base unit 22 is guided such that the center hole 2a of the optical disk 2 and the turntable 23a of the disk mounting section 23 are aligned.

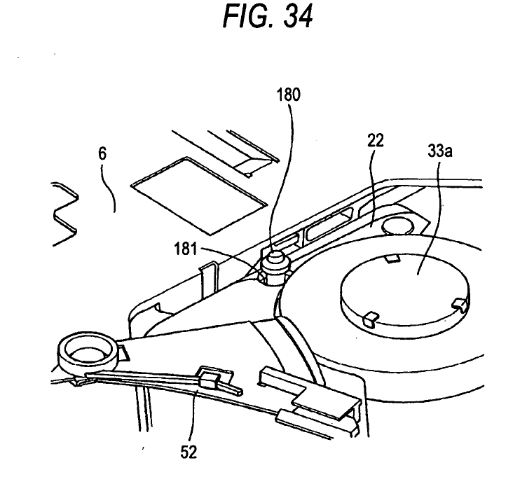

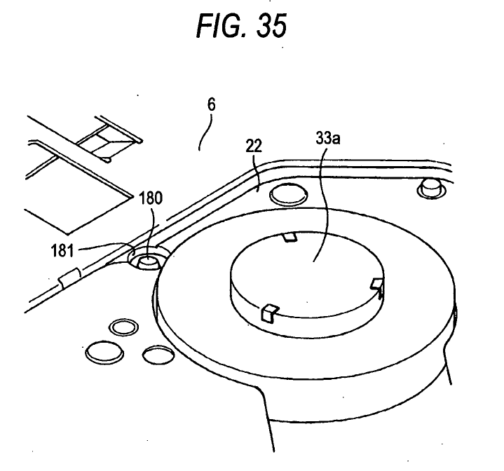

Specifically, as shown in FIG. 34 and indicated by an alternate long and two short dashes line in (a) in FIG. 33, when the base unit 22 is lowered to the chucking release position, the flange section 182 of the guide pin 180 is located above the guide hole 181. When the optical disk 2 is conveyed to the centering position, the base chassis 27 is lifted and the flange section 182 is inserted through the guide hole 181. When the base chassis 27 is lifted to the chucking position for the optical disk 2, as shown in FIG. 35 and indicated by a solid line in (b) in FIG. 33, the guide walls 185 formed to swell in the guide hole 181 slide on the first guide section 183 of the guide pin 180 and the flange section 182 is inserted through the clearance between the guide walls 185. In this way, when the base chassis 27 is lifted while being guided by the guide pin 180, the turntable 23a of the disk mounting section 23 is aligned with the center hole 2a of the optical disk 2 conveyed to the centering position. Thus, it is possible to smoothly perform chucking without applying excessive loads on the optical disk 2 and the turntable 23a.

The guide pin 180 and the guide hole 181 are formed near the disk mounting section 23 at the other end on the opposite side of one end in the longitudinal direction where the third supporting shaft 49, which supports the rotation of the base unit 22, is provided. Thus, it is possible to most efficiently correct deviation between the optical disk 2 conveyed to the centering position and the turntable 23a. This makes it possible to surely align the center hole 2a of the optical disk 2 and the engaging projection 33a of the turntable 23a.

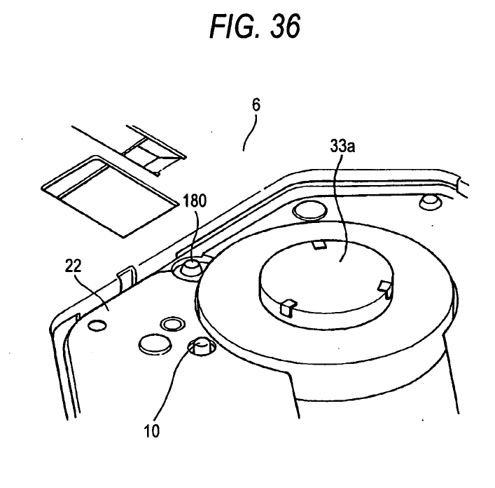

Subsequently, as shown in FIG. 36 and indicated by an alternate long and short dash line in (c) in FIG. 33, when the base unit 22 is lowered to the recording and reproduction position, the guide walls 185 of the guide hole 181 of the base chassis 27 slide on the second guide section 184 of the flange section 182. The flange section 182 is guided by the guide hole 181 such that the flange section 182 can be inserted through the guide hole 181. Then, the guide walls 185 are lowered to a position where the guide walls 185 separate from the flange section 182. In a state in which the base unit 22 is lowered to the recording and reproduction position in this way, the guide pin 180 and the guide hole 181 are not in contact with each other. Thus, disturbance such as vibration is prevented from being transmitted from the bottom case 4 to the base chassis 27 side via the guide pin 180. Therefore, it is possible to prevent the disturbance from being transmitted to the disk-rotation driving mechanism 24 and the optical pickup 25 through the guide pin 180 to adversely affect recording and reproduction characteristics.

The guide pin 180 is formed at height not allowing the guide pin 180 to come into contact with the lower surface of the optical disk 2 driven to rotate by the disk-rotation driving mechanism 24. Thus, it is unlikely that an information recording surface of the optical disk 2 is scratched.

When the recording or reproduction operation is completed and the disk drive device 1 shifts to a process for ejecting the optical disk 2, the base unit 22 is lowered to the chucking release position. The optical disk 2 is pushed up from the turntable 23 by the push-up pin 10 to release chucking. In this case, in the base chassis 27, the guide hole 181 is located below the guide pin 180.

In the disk drive device 1 according to the embodiment, it is also possible to use the guide pin 180 as the push-up pin 10 that releases chucking of the optical disk 2. The upper end of the guide pin 180 may be formed in a semi-spherical shape and the guide pin 180 and the guide hole 181 of the base chassis 27 may be formed in association with a non-recording area formed near the center hole 2a of the optical disk 2 mounted on the turn table 23a. Consequently, when the base unit 22 is lowered to the chucking release position for the optical disk 2, the optical disk 2 is pushed up by the upper end of the guide pin 180 and chucking with the turntable 23a is released. According to such a constitution, since it is unnecessary to use the push-up pin 10 in addition to the guide pin 180, it is possible to reduce the number of components and reduce weight of the disk drive device 1.

In the disk drive device according to an embodiment of the invention, when the eject arm is in a state of standby for insertion of a large-diameter disk-like recording medium, the stopper provided in the eject arm is rotationally moved to a position where the stopper is brought into contact with an insertion end face of a small-diameter disk-like recording medium when substantially the entire small-diameter disk-like recording medium is inserted from the disk slot. In other words, the stopper is brought into contact with the small-diameter disk-like recording medium when substantially the entire small-diameter disk-like recording medium is inserted. Therefore, since the small-diameter disk-like recording medium is brought into contact with the stopper in a state in which a portion that an operator can push into the inside of the device from the outside of the disk slot is hardly left, further insertion of the small-diameter disk-like recording medium is regulated. Consequently, it is difficult for the operator to insert the small-diameter disk-like recording medium into the inside of the device.

It should be understood by those skilled in the art that various modifications, combinations, sub-combinations, and alterations may occur depending on design requirements and the other factors insofar as they are within the scope of the appended claims or the equivalents thereof.

What is claimed is:

1. A disk drive device comprising:
a housing provided with a disk slot in which a large-diameter disk-like recording medium is inserted and from which the recording medium is ejected;
an eject arm that ejects the large-diameter disk-like recording medium; and
a disk conveying mechanism that rotationally moves at least the eject arm to an ejection position of the large-diameter disk-like recording medium, wherein
the eject arm is provided with a stopper that prevents insertion of a small-diameter disk-like recording medium and, when the eject arm is rotationally moved to the ejection position, the stopper is rotationally moved to a position where the stopper is brought into contact with a side on an insertion end side of the small-diameter disk-like recording medium when substantially the entire small-diameter disk-like recording medium is inserted from the disk slot.

2. A disk drive device according to claim 1, wherein the eject arm has a rotation supporting member, a push-out arm rotationally movably attached to the rotation supporting member, and a contact member provided with the stopper and brought into contact with the large-diameter disk-like recording medium and is rotationally moved to the ejection position in a state in which the disk drive device stands by for insertion of the large-diameter disk-like recording medium.

3. A disk drive device according to claim 2, wherein a clearance between the contact member in the ejection position and both ends in a longitudinal direction of the disk slot is smaller than a diameter of the small-diameter disk-like recording medium.

4. A disk drive device according to claim 1, wherein
the eject arm is provided on a side of one side of the housing and the stopper is formed at a tip of the eject arm, and.
the eject arm is formed in length not allowing the stopper to rotationally move on a disk mounting section that is provided in substantially a center of the housing and on which the large-diameter disk-like recording medium is mounted.
